(19) United States
(12) Patent Application Publication
(10) Pub. No.: US 2013/0261270 A1
(43) Pub. Date: Oct. 3, 2013

(54) POLYAMINES HAVING SECONDARY ALIPHATIC AMINO GROUPS

(71) Applicants: Pierre-Andre Butikofer, Wallisellen (CH); Urs Burckhardt, Zurich (CH)

(72) Inventors: Pierre-Andre Butikofer, Wallisellen (CH); Urs Burckhardt, Zurich (CH)

(73) Assignee: SIKA TECHNOLOGY AG, Baar (CH)

(21) Appl. No.: 13/992,473

(22) PCT Filed: Dec. 13, 2011
(86) PCT No.: PCT/EP2011/072629

§ 371 Date: Jun. 7, 2013

(30) Foreign Application Priority Data
Dec. 17, 2010 (EP) 10195809.8

(51) Int. Cl. C08G 12/06; C08G 59/50; C08G 18/06; C08G 73/06; C08G 12/40

(52) U.S. Cl. CPC C08G 12/06; C08G 73/0694; C08G 12/40; C08G 18/06; C08G 59/5013
USPC 525/423; 528/266; 528/341; 525/473; 525/424; 525/452

(57) ABSTRACT

The present invention relates to novel polyamines having secondary amino groups, a process for producing them, adducts of these polyamines and their uses. The polyamines can be prepared in a simple way from readily available reactants. They and their adducts have, in particular, a low viscosity and are suitable as constituent of polyurethane and polyurea compositions having excellent processability and high flexibility, and also constituent of epoxy resin compositions, especially coatings.

### TECHNICAL AREA

The invention relates to novel polyamines and the use thereof, especially as curing agents in curable compositions, especially those based on epoxides or isocyanates, as well as polyamine-containing curable compositions and their use especially as coatings, facings and paints.

### PRIOR ART

Polyamines are frequently used as curing agents in curable compositions, especially in epoxy resin, polyurethane or polyurea compositions. The polyamines usually used in epoxy resin compositions have a high content of primary amino groups, which react with carbon dioxide gas (CO₂) from air and can thus form stable carbonate and carbamate salts. On one hand this means that curing agents based on such polyamines cannot be stored exposed to air, since crusts would form in their containers. On the other hand, epoxy resin compositions made with such curing agents can absorb CO₂ during and after application, which can cause defects such as clouding, spots, or rough or tacky surfaces, extending to incomplete curing, especially in coating applications. Such CO₂-related effects are known by persons skilled in the art as “blushing.” To reduce blushing effects and for dilution, benzyl alcohol is frequently added to the curing agents, but this in turn has drawbacks, since benzyl alcohol is undesirable in many applications because of its volatility, and large amounts of benzyl alcohol substantially impair the mechanical properties of cured epoxy resin. Polyols and polyamines are used as curing agents in polyurethane and polyurea compositions. In such cases, polyols have the drawback that their reactivity toward isocyanates is as high as the reactivity of isocyanates with water, and in the presence of high relative humidity or direct contact with water, CO₂ formed during the reaction of the isocyanates with water can lead to development of blisters and foam or surface tackiness and reduced adhesion and strength of the cured composition. Furthermore, considerable quantities of catalysts are typically added to make the curing proceed quickly enough at room temperature, and this can entail drawbacks, for example in terms of toxicity or durability of the compositions. To avoid these problems, it is basically attractive to use polyamines rather than polyols as curing agents, since polyamines have a substantially higher reactivity toward isocyanates, scarcely competing with water, and they do not require catalysts. However, the usual aliphatic polyamines are so reactive toward many isocyanates that they can hardly be mixed into a polyisocyanate, even using mechanical devices, before the mixture solidifies. Therefore inhomogeneous, optically and mechanically unsatisfactory products are produced, and problems with flow and substrate wetting occur. To be sure, aromatic polyamines are less reactive, but they are highly toxic and not photostable, so that compositions cured with them yellow rapidly.

Among the aliphatic polyamines, those with mostly secondary amino groups are more hydrophobic and less reactive than those with mostly primary amino groups; they show scarcely any tendency toward blushing. In addition they are generally less volatile and do not have such a strong odor. As a result, they are basically attractive as curing agents in epoxy resin, polyurethane or polyurea compositions. Many of the known polyamines with predominantly secondary amino groups, however, are solid or highly viscous at room temperature, which interferes with their processability into curable compositions and may sometimes require the use of solvents, which is undesirable for many applications. In terms of their reactivity and compatibility as well, the known polyamines with principally secondary amino groups often do not fulfill the requirements for successful use in curable compositions based on epoxy resins or polyisocyanates.

Since a number of polyamines with mostly primary amino groups are commercially available, it seems an attractive approach to produce polyamines with mostly secondary amino groups based on these.

One known pathway to secondary amino groups is the addition reaction of primary amino groups with Michael acceptors, especially acrylonitrile, acrylates or maleates. These reagents are inexpensive and the reaction proceeds even under mild conditions. However, it usually takes place slowly and incompletely, and therefore leaves behind some of the Michael acceptors in unreacted form, which may need to be removed afterward to prevent an unpleasant odor of the products. The use of esters as Michael acceptors can also lead to the formation of unwanted byproducts, since ester groups can react with secondary and especially primary amino groups, forming amides.

An additional known pathway to secondary amino groups is the reductive alkylation of primary amino groups with ketones or aldehydes. Polyamines produced in this way, with mainly secondary amino groups, are described for example in U.S. Pat. No. 4,126,640; EP 0 438 695 and U.S. Pat. No. 5,739,209. When ketones are used, polyamines with highly sterically hindered secondary amino groups, which usually have low reactivity, form. The aldehydes used in the prior art can cause other problems. For example, simple aliphatic aldehydes such as formaldehyde or acetaldehyde lead to the formation of unwanted byproducts by over-alkylation and aminal formation, while more highly substituted aliphatic aldehydes, such as isobutyraldehyde or 2-ethylhexanal, often give products that are insufficiently compatible with epoxy resins. Amination with benzaldehyde and other aromatic aldehydes may be incomplete, since the benzyl group can be split off again under the hydrogenation conditions.

Thus there is a need for low-viscosity polyamines, liquid at room temperature, with secondary aliphatic amino groups, which exhibit good compatibility with epoxy resins and polyurethane and polyurea compositions, and which do not have excessively high reactivity toward isocyanates.

### PRESENTATION OF THE INVENTION

Therefore the goal of the present invention is to supply new polyamines with secondary aliphatic amino groups which can be produced easily, can be used as curing agents in curable compositions, especially those based on epoxy resins or polyisocyanates, and do not have the drawbacks of the polyamines known from the prior art.

Surprisingly it was found that polyamines according to claim 1 accomplish this goal. These are typically liquid, relatively low-viscosity compounds with low volatility and little odor. They have such low reactivity toward CO₂ that when exposed to air they do not show a tendency to form crusts or precipitates or undergo a viscosity increase. In addition they can be produced in high purity and in a simple process that does not require any complicated workup steps by reductive alkylation of commercial polyamines containing primary amino groups with aldehydes which have an aldehyde group located on a tertiary C atom and at least one secondary or tertiary amino group.

The polyamines according to claim 1 have good compatibility both with epoxy resins and with polyurethane and polyurea compositions. They are especially suitable as curing agents in epoxy resin coatings, as they have little blushing effect and in particular are free from solvents, benzyl alcohol and similar diluents. Furthermore they are especially suitable as curing agents in polyurethanes and polyurea compositions, since they exhibit moderate reactivity with isocyanate groups and therefore make available rapidly curing coatings with readily manageable processing speeds.

Additional aspects of the invention are the subjects of additional independent claims. Particularly preferred embodiments of the invention are the subjects of dependent claims.

### Pathways for Having Out the Invention

An object of the invention is a polyamine of Formula (I)

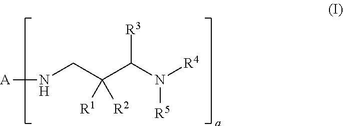

wherein
A represents the radical of an amine after removal of a primary aliphatic amino group; a represents an integer from 1 to 6, with the specification that if a=1 the radical A represents at least one reactive group selected from the group consisting of primary amino groups, secondary amino groups, hydroxyl groups and mercapto groups;
R¹ and R² represent either
independently of one another, each one a monovalent hydrocarbon with 1 to 12 C atoms,
or taken together, a divalent hydrocarbon radical with 4 to 12 C atoms, which is part of an optionally substituted carbocyclic ring with 5 to 8, preferably 6, C atoms;
   R³ represents a hydrogen atom or an alkyl group or an arylalkyl group or alkoxycarbonyl group with 1 to 12 C atoms in each case; and either
R⁴ represents a monovalent aliphatic, cycloaliphatic or arylaliphatic radical with 1 to 20 C atoms, which optionally contains oxygen atoms, and
R⁵ represents a hydrogen atom or a monovalent aliphatic, cycloaliphatic or arylaliphatic radical with 1 to 20 C atoms, which optionally contains oxygen atoms,
   or
R⁴ and R⁵ together represent a divalent aliphatic radical with 3 to 30 C atoms which is part of an optionally substituted heterocyclic ring with 5 to 8, preferably 6, ring atoms, wherein this ring in addition to the nitrogen atom optionally contains additional heteroatoms.

Substance names beginning with “poly,” such as polyamine, polyol or polyepoxide, designate substances which in each molecule formally contain two or more of the functional groups present in their name.

A “primary amino group” is the term applied to an NH₂ group bound to one organic radical; “secondary amino group” is the term applied to an NH group that is bound to two organic radicals, which may also together form part of a ring; and “tertiary amino group” is the term applied to an amino group, the nitrogen atom of which (“tertiary amine nitrogen”) is bound to three organic radicals, wherein two of these radicals together may also be part of a ring.

“Aliphatic” is the term applied to an amine or isocyanate in which the amino or isocyanate groups are respectively bound to aliphatic, cycloaliphatic or arylaliphatic groups; correspondingly these groups are designated as aliphatic amino or aliphatic isocyanate groups.

“Aromatic” is the term applied to an amine or an isocyanate in which the amino or isocyanate groups are respectively bound to an aromatic radical; correspondingly these groups are designated as aromatic amino or aromatic isocyanate groups.

The term “primary aliphatic polyamine” is applied to a substance that contains two or more primary aliphatic amino groups per molecule in its Formula. A “secondary aliphatic polyamine” is the term applied to a substance which contains two or more secondary aliphatic amino groups per molecule in its Formula.

The term “curable composition” covers liquid or fusible reactive organic compositions and mixtures thereof which are at least partially synthetically produced and can cure to form plastics and plastic compositions by themselves and/or by contact with air.

The term “curing agent” designates compounds with at least two reactive groups, for example in the form of primary or secondary amino groups, hydroxyl groups or mercapto groups, which can serve as reaction partners in the curing of curable compositions into plastics.

The term “polymer” on one hand covers a population of macromolecules, produced by a polyreaction (polymerization, polyaddition, polycondensation), that are chemically uniform but differ from one another in terms of their degree of polymerization, molecular weight and chain length. On the other hand, the term also includes derivatives of such a group of macromolecules originating from polyreactions, thus compounds that were obtained by reactions, such as additions or substitutions, of functional groups onto pre-existing macromolecules, and which can be chemically uniform or chemically non-uniform. The term also includes so-called prepolymers, in other words, reactive oligomeric pre-adducts, the functional groups of which are involved in the makeup of macromolecules.

“Room temperature” means a temperature of 23° C.

The term “compatible” or “compatibility” when related to a curing agent of a curable composition indicates that the curing agent can be incorporated fairly homogeneously into this composition and during the curing [of the composition] does not cause any of the defects attributable to demixing phenomena, especially film clouding or surface imperfections in the form of markings, structures or flotation.

The bold-face terms such as PA, ALD, Y1, Y2, C, VB, RG, AD, AM, AD2, Z1, Z2, PUP, PI, HV, S and the like are used only for better comprehension and identification by the reader.

A preferably represents an a-valent hydrocarbon radical with a molecular weight in the range of 28 to 10,000 g/mol, which optionally contains ether groups, amino groups, hydroxyl groups or mercapto groups.

Particularly preferably, A represents an a-valent hydrocarbon radical with a molecular weight in the range of 28 to 10,000 g/mol, which optionally contains ether groups or primary or secondary amino groups.

Preferably, a is 1 to 3, particularly preferably 2 or 3.

Preferably R¹ and R² each is a methyl radical.

Preferably R³ is a hydrogen atom.

In particular therefore each of R¹ and R² is a methyl radical and/or R³ is a hydrogen atom.

Preferably R⁴ is methyl, ethyl, propyl, isopropyl, butyl, 2-ethylhexyl, cyclohexyl, 2-hydroxyethyl, 2-hydroxypropyl, 2-methoxyethyl or benzyl and R⁵ is hydrogen or methyl, ethyl, propyl, isopropyl, butyl, 2-ethylhexyl, cyclohexyl, 2-hydroxyethyl, 2-hydroxypropyl, 2-methoxyethyl or benzyl.

Also preferably, R⁴ and R⁵ together—including the nitrogen atom—form a ring, especially a pyrrolidine, piperidine, morpholine or N-alkylpiperazine ring, wherein this ring or the alkyl group is optionally substituted.

Advantageously the radical A contains no alkoxysilane groups.

A polyamine of Formula (I) can be produced by reductive alkylation of at least one amine PA of Formula (II) with at least one aldehyde ALD of Formula (III).

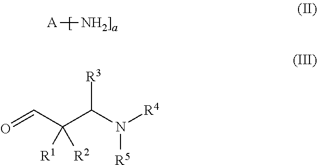

In Formulas (II) and (III), A, a, R¹, R², R³, R⁴ and R⁵ have the previously mentioned meanings.

The aldehyde ALD can be used stoichiometrically or in stoichiometric excess relative to the primary amino groups of the amine PA, wherein polyamines of Formula (I) free from primary amino groups are obtained. If the amine PA has at least 2 primary amino groups, the aldehyde ALD can also be used in a substoichiometric quantity relative to the primary amino group of the amine PA. In this case polyamines of Formula (I) form, which alongside secondary and optionally tertiary amino groups, additionally have primary amino groups.

In particular, a polyamine of Formula (I) is obtainable from the condensation of at least one amine PA of Formula (II) with at least one aldehyde ALP of Formula (III) to form an imine of Formula (IV), which is then hydrogenated.

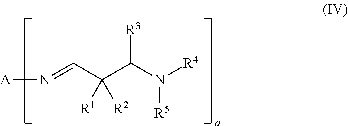

In Formula (IV), A, a, R¹, R², R³, R⁴ and R⁵ have the previously mentioned meanings.

The preparation of a polyamine of Formula (I) can be performed directly from the reactants in a one-pot reaction by hydrogenation. The imine of Formula (IV), however, can also be isolated as an intermediate product and optionally purified, then hydrogenated in a second reaction step.

The water released during the condensation to the imine of Formula (IV) need not be removed in the process, but instead can remain in the reaction mixture during hydrogenation. After hydrogenation, water, optionally along with a solvent that may be present, can be removed, for example by distillation.

The hydrogenation for producing a polyamine of Formula (I) can be performed directly with molecular hydrogen or indirectly by hydrogen transfer from other reagents. Examples of such reagents are formic acid, with release of CO₂ (in accordance with a Leuckart-Wallach reaction); cyclohexene, which undergoes dehydrogenation to benzene, as well as other alkenes such as limonene; organosilanes; alkali metals in protic solvents; or hydrazine in the presence of an oxidizing agent. The term “hydrogenation” here will also include reduction with hydrides, for example lithium aluminum hydride, sodium borohydride and sodium-bis(2-methoxyethoxy)aluminum hydride (Vitride®, Red-Al®). Hydrogenation with molecular hydrogen is preferred.

The hydrogen required for hydrogenation is preferably used at elevated pressure, especially 5 to 250 bar, and elevated temperature, especially 20 to 160° C., in the presence of a suitable catalyst. The conditions are advantageously selected such that on one hand the imino groups are completely hydrogenated insofar as possible and on the other hand insofar as possible no additional constituents of the imine according to Formula (IV) are hydrogenated or degraded.

Suitable catalysts for the hydrogenation are homogeneous catalysts, for example rhodium, ruthenium or iridium complexes, and especially heterogeneous catalysts, for example platinum, palladium, rhodium, ruthenium, osmium, rhenium, nickel, cobalt or iron, and compounds thereof or preparations on support materials, especially pumice, diatomaceous earth, aluminum, silica gel or active carbon. Particularly suitable are palladium on carbon (Pd/C), platinum on carbon (Pt/C), Adams catalyst and Raney nickel. Palladium on carbon and platinum on carbon are preferred.

The reductive alkylation is preferably performed in the liquid phase. It can optionally take place without solvent or in the presence of a solvent, wherein suitable solvents are inert under the reaction conditions. Especially suitable as solvents are C₁ to C₁₀ alkanes, for example hexane, heptane or cyclohexane, and alcohols, especially primary C₁ to C₆ alcohols such as methanol or ethanol, but also secondary alcohols such as isopropanol and tertiary alcohols such as tert-butanol.

The hydrogenation can be performed stepwise or in a continuous process, for example in a continuously operating hydrogenation apparatus. The substance to be hydrogenated, optionally in solution, is mixed continuously with hydrogen under pressure and passed through a suitable catalyst. In this process the hydrogen can be generated continuously by electrolysis with water.

In a preferred method for producing a polyamine of Formula (I), at least one amine PA of Formula (II), at least one aldehyde ALD of Formula (III) and optionally at least one suitable solvent are mixed together, then the reaction mixture hydrogenated with a suitable method, and subsequently the water liberated from the imine formation, optionally together with the solvent, is removed by applying a vacuum.

In a particularly preferred method for producing a polyamine of Formula (I), at least one amine PA of Formula (II), at least one aldehyde ALD of Formula (III) and optionally at least one suitable solvent are mixed together; the reaction mixture is then hydrogenated in a continuous process, and then the water released from the imine formation, optionally along with the solvent, is removed by applying a vacuum. The mixing of the amine PA and the aldehyde ALD of Formulas (II) and (III) can be performed either batchwise or continuously.

Suitable amines PA of Formula (II) in a first embodiment are primary aliphatic polyamines, which are known as curing agents in epoxide group- or isocyanate group-containing curable compositions, especially the following:
Aliphatic, cycloaliphatic or arylaliphatic primary diamines, in particular ethylenediamine, 1,2-propanediamine, 1,3-propanediamine, 2-methyl-1,2-propanediamine, 2,2-dimethyl-1,3-propanediamine, 1,3-butanediamine, 1,4-butanediamine, 1,3-pentanediamine (DAMP), 1,5-pentanediamine, 1,5-diamino-2-methylpentane (MPMD), 2-butyl-2-ethyl-1,5-pentanediamine (C11-neodiamine), 1,6-hexanediamine, 2,5-dimethyl-1,6-hexanediamine, 2,2,4- and 2,4,4-trimethyl-hexamethylenediamine (TMD), 1,7-heptanediamine, 1,8-octanediamine, 1,9-nonanediamine, 1,10-decanediamine, 1,11-undecanediamine, 1,12-dodecanediamine, 1,2-, 1,3- and 1,4-diaminocyclohexane, bis-(4-aminocyclohexyl)-methane (H₁₂-MDA), bis-(4-amino-3-methylcyclohexyl)-methane, bis-(4-amino-3-ethylcyclohexyl)-methane, bis-(4-amino-3,5-dimethylcyclohexyl)-methane, bis-(4-amino-3-ethyl-5-methylcyclohexyl)-methane (M-MECA), 1-amino-3-aminomethyl-3,5,5-trimethylcyclohexane (=isophorone diamine or IPDA), 2- and 4-methyl-1,3-diaminocyclohexane and mixtures thereof, 1,3- and 1,4-bis-(aminomethyl)-cyclohexane, 2,5(2,6)-bis-(aminomethyl)-bicyclo[2.2.1]heptane (NBDA), 3(4),8(9)-bis-(aminomethyl)-tricyclo[5.2.1.0^{2,6}]decane, 1,4-diamino-2,2,6-trimethylcyclohexane (TMCDA), 1,8-menthanediamine, 3,9-bis-(3-aminopropyl)-2,4,8,10-tetraoxaspiro[5.5]undecane and 1,3- and 1,4-xylylenediamine;
Aliphatic, cycloaliphatic or arylaliphatic primary triamines such as 4-aminomethyl-1,8-octanediamine, 1,3,5-tris-(aminomethyl)-benzene, 1,3,5-tris-(aminomethyl)-cyclohexane, tris-(2-aminoethyl)-benzene, tris-(2-aminopropyl)-amine, tris-(3-aminopropyl)-amine;
Ether group-containing aliphatic primary diamines, in particular bis-(2-aminoethyl)ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxamidecane-1,13-diamine and higher oligomers of these diamines, bis-(3-aminopropyl)-polytetrahydrofurans and other polytetrahydrofuran diamines, as well as polyoxyalkylene diamines. The latter are typically products from the amination of polyoxyalkylene diols and are available for example under the name of Jeffamine® (from Huntsman), under the name of polyetheramines (from BASF) or under the name of PC Amine® (from Nitroil). Particularly suitable polyoxyalkylene-diamines are Jeffamine® D-230, Jeffamine® D-400, Jeffamine® D-2000, Jeffamine® D-4000, Jeffamine® XTJ-511, Jeffamine® ED-600, Jeffamine® ED-900, Jeffamine® ED-2003, Jeffamine® XTJ-568, Jeffamine® XTJ-569, Jeffamine® XTJ-523, Jeffamine® XTJ-536, Jeffamine® XTJ-542, Jeffamine® XTJ-559, Jeffamine® EDR-104, Jeffamine® EDR-148, Jeffamine® EDR-176; Polyetheramine D 230, Polyetheramine D 400 and Polyetheramine D 2000, PC Amine® DA 250, PC Amine® DA 400, PC Amine® DA 650 and PC Amine® DA 2000;
Primary polyoxyalkylene triamines, which are typically products from the amination of polyoxyalkylene triols and for example are available under the name of Jeffamine® (from Huntsman), under the name of Polyetheramine (from BASF) or under the name of PC Amine® (from Nitroil), in particular Jeffamine® T-403, Jeffamine® T-3000, Jeffamine® T-5000, Polyetheramine T 403, Polyetheramine T 5000 and PC Amine® TA 403;
Tertiary amino group-containing polyamines with two primary aliphatic amino groups, in particular N,N′-bis-(aminopropyl)-piperazine, N,N-bis-(3-aminopropyl)-methylamine, N,N-bis-(3-aminopropyl)-ethylamine, N,N-bis-(3-aminopropyl)-propylamine, N,N-bis-(3-aminopropyl)cyclohexylamine, N,N-bis-(3-aminopropyl)-2-ethyl-hexylamine, as well as the products from the double cyanoethylation and subsequent reduction of fatty amines derived from natural fatty acids, such as N,N-bis-(3-aminopropyl)-dodecylamine and N,N-bis-(3-aminopropyl)-tallow-alkylamines, available as Triameen® Y12D and Triameen® YT (from Akzo Nobel);
Tertiary amino group-containing polyamines with three primary aliphatic amino groups, in particular tris-(2-aminoethyl)-amine, tris-(2-aminopropyl)-amine and tris-(3-aminopropyl)-amine;
Secondary amino group-containing polyamines with two primary aliphatic amino groups, in particular 3-(2-aminoethyl)aminopropyl-amine, bis-hexamethylene triamine (BHMT), diethylene triamine (DETA), triethylene tetramine (TETA), tetraethylene pentamine (TEPA), pentaethylene hexamine (PEHA) and higher homologs of linear polyethyleneamines such as polyethylene polyamine with 5 to 7 ethyleneamine units (so-called “higher ethylene-polyamines,” HEPA), products of multiple cyanoethylation or cyanobutylation and subsequent hydrogenation of primary di- and polyamines with at least two primary amino groups, such as dipropylene triamine (DPTA), N-(2-aminoethyl)-1,3-propane diamine (N3-amine), N,N′-bis(3-aminopropyl)-ethylene-diamine (N4-amine), N,N′-bis-(3-aminopropyl)-1,4-diaminobutane, N5-(3-aminopropyl)-2-methyl-1,5-pentanediamine, N3-(3-aminopentyl)-1,3-pentanediamine, N5-(3-amino-1-ethylpropyl)-2-methyl-1,5-pentanediamine and N,N′-bis-(3-amino-1-ethylpropyl)-2-methyl-1,5-pentanediamine.

In an additional embodiment, suitable amines PA of Formula (II) are polyamines with only one primary aliphatic amino group and at least one additional reactive group selected from the group consisting of secondary amino groups, hydroxyl groups and mercapto groups.

Particularly suitable polyamines with one primary aliphatic amino group and at least one secondary amino group are N-methyl-1,2-ethanediamine, N-ethyl-1,2-ethanediamine, N-butyl-1,2-ethanediamine, N-hexyl-1,2-ethanediamine, N-(2-ethylhexyl)-1,2-ethanediamine, N-cyclohexyl-1,2-ethanediamine, 4-aminomethyl-piperidine, 3-(4-aminobutyl)-piperidine, N-(2-aminoethyl)-piperazine, N-(2-amino-propyl)-piperazine, N¹-(3-(dimethylamino)propyl)-1,3-diaminopropane (DMAPAPA), N¹-(2-(dimethylamino)ethyl)propane-1,3-diamine, diamines from the cyanoethylation or cyanobutylation and subsequent hydrogenation of primary monoamines, for example N-methyl-1,3-propanediamine, N-ethyl-1,3-propanediamine, N-butyl-1,3-propanediamine, N-hexyl-1,3-propanediamine, N-(2-ethylhexyl)-1,3-propanediamine, N-dodecyl-1,3-propanediamine, N-cyclohexyl-1,3-propanediamine, 3-methylamino-1-pentylamine, 3-ethylamino-1-pentylamine, 3-butylamino-1-pentylamine, 3-hexylamino-1-pentylamine, 3-(2-ethylhexyl)amino-1-pentylamine, 3-dodecylamino-1-pentylamine, 3-cyclohexylamino-1-pentylamine, and fatty diamines such as N-cocoalkyl-1,3-propanediamine, N-oleyl-1,3-propanediamine, N-soyaalkyl-1,3-propanediamine, N-tallow alkyl-1,3-propanediamine or N—(C₁₆₋₂₂-alkyl)-1,3-propanediamine, such as are obtainable under the trade name Duomeen® from Akzo Nobel; triamines and tetramines derived from fatty amines, such as cocoalkyl dipropylenetriamine, oleyl dipropylenetriamine, tallow alkyl dipropylenetriamine, oleyl tripropylenetetramine and tallow alkyl tripropylenetetramine, available for example as Triameen® C, Triameen® OV, Triameen® T, Tetrameen® OV and Tetrameen® T (Akzo Nobel); the products from the Michael-like addition reaction of primary aliphatic diamines with acrylonitrile, maleic or fumaric acid diesters, citraconic acid diesters, acrylates and methacrylates, acrylamides and methacrylamides and itaconic acid diesters, reacted in a 1:1 molar ratio.

Particularly suitable polyamines with one primary aliphatic amino group and at least one hydroxyl group suitable include 2-aminoethanol, 2-amino-1-propanol, 1-amino-2-propanol, 3-amino-1-propanol, 4-amino-1-butanol, 4-amino-2-butanol, 2-amino-2-methylpropanol, 5-amino-1-pentanol, 6-amino-1-hexanol, 7-amino-1-heptanol, 8-amino-1-octanol, 10-amino-1-decanol, 12-amino-1-dodecanol and higher homologs thereof, aminopropyl-diethanolamine (APDEA), 4-(2-aminoethyl)-2-hydroxyethylbenzene, 3-aminomethyl-3,5,5-trimethyl-cyclohexanol, glycol derivatives having one primary amino group, such as diethylene glycol, dipropylene glycol, dibutylene glycol and higher oligomers and polymers of these glycols, especially 2-(2-aminoethoxy)-ethanol, 2-(2-(2-aminoethoxy)ethoxy)-ethanol, α-(2-hydroxymethylethyl)-ω-(2-aminomethylethoxy)-poly(oxy(methyl-1,2-ethanediyl)); derivatives of polyalkoxylated trivalent or higher-valent alcohols having one hydroxyl group and one primary amino group; products from the single cyanoethylation and subsequent hydrogenation of glycols, especially 3-(2-hydroxyethoxy)-propylamine, 3-(2-(2-hydroxyethoxy)-ethoxy)-propylamine and 3-(6-hydroxyhexyloxy)-propylamine; as well as other aliphatic polyamines with one primary and one secondary amino group and one hydroxyl group, in particular N-hydroxyethyl-1,3-propanediamine, N-hydroxypropyl-1,3-propanediamine and N3-hydroxyethyl-1,3-pentanediamine.

Especially suitable as polyamines with one primary aliphatic amino group and at least one mercapto group are 2-aminoethanethiol (cysteamine), 3-aminopropanethiol, 4-amino-1-butanethiol, 6-amino-1-hexanethiol, 8-amino-1-octanethiol, 10-amino-1-decanethiol and 12-amino-1-dodecanethiol.

Primary aliphatic polyamines are preferred as the amine PA of Formula (II).

Particularly preferred is the amine PA of Formula (II) selected from the group consisting of 1,5-diamino-2-methylpentane (MPMD), 2-butyl-2-ethyl-1,5-pentanediamine (C11-neodiamine), 1,6-hexanediamine, 2,5-dimethyl-1,6-hexanediamine, 2,2,4- and 2,4,4-trimethyl-hexamethylene diamine (TMD), 1,12-dodecane diamine, 1,4-diamino-cyclohexane, bis-(4-aminocyclohexyl)-methane (H₁₂-MDA), bis-(4-amino-3-methylcyclohexyl)-methane, 1-amino-3-aminomethyl-3,5,5-trimethylcyclohexane (=isophorone diamine or IPDA), 1,3-bis-(aminomethyl)cyclohexane, 2,5(2,6)-bis-(aminomethyl)-bicyclo[2.2.1]-heptane (NBDA), 3(4),8(9)-bis-(aminomethyl)-tricyclo-[5.2.1.0^{2,6}]-decane, 1,3-xylylenediamine, bis-hexamethylene triamine (BHMT), diethylene triamine (DETA), triethylene tetramine (TETA), tetraethylene pentamine (TEPA), pentaethylene hexamine (PEHA), polyethylene polyamine with 5 to 7 ethyleneamine units (so-called “higher ethylene polyamines,” HEPA), dipropylene triamine (DPTA), N-(2-aminoethyl)-1,3-propanediamine (N3-amine), N,N′-bis(3-aminopropyl)ethylenediamine (N4-amine), polyoxyalkylene diamines and polyoxyalkylene triamines, especially with a molecular weight of 200 to 6000 g/mol, especially the commercial types Jeffamine® D-230, Jeffamine® D-400, Jeffamine® D-2000, Jeffamine® D-4000, Jeffamine® T-403, Jeffamine® T-3000 and Jeffamine® T-5000 (from Huntsman).

Especially suitable as the aldehyde ALD of Formula (III) are the products from an α-aminoalkylation analogous to the Mannich reaction, such as is known from the technical literature. In this reaction, an aldehyde Y1 of Formula (V), an aldehyde Y2 of Formula (VI) and a primary or secondary aliphatic amine C of Formula (VII) are reacted to form an aldehyde ALD of Formula (III) with splitting off of water.

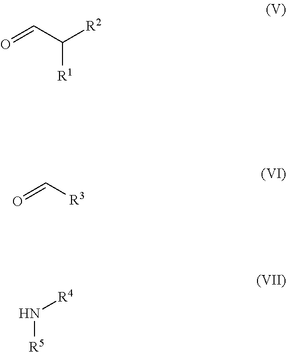

In Formulas (V), (VI) and (VII), R¹, R², R³, R⁴ and R⁵ have the aforementioned meanings.

This reaction can be performed either with the free reagents Y1, Y2 and C according to Formulas (V), (VI) and (VII), or the reagents can be used partially or completely in derivatized form. In a preferred embodiment, the reaction is performed with all reagents in free farm as a one-pot reaction and following the reaction, the aldehyde ALD is purified by distillation. Preferably no organic solvent is used in this process.

Especially suitable aldehydes Y1 of Formula (V) are isobutyraldehyde, 2-methylbutyraldehyde 2-ethylbutyraldehyde, 2-methylvaleraldehyde, 2-ethylcaproic aldehyde, cyclopentane carboxaldehyde, cyclohexane carboxaldehyde, 1,2,3,6-tetrahydrobenzaldehyde, 2-methyl-3-phenylpropionaldehyde, 2-phenylpropionaldehyde and diphenylacetaldehyde. Isobutyraldehyde is preferred.

Especially suitable as the aldehyde Y2 of Formula (VI) are formaldehyde, acetaldehyde, propionaldehyde, butyraldehyde, isobutyraldehyde, phenylacetaldehyde and glyoxylic acid esters, especially ethyl glyoxylate. Formaldehyde is preferred.

Especially suitable as the amine C of Formula (VII) are methylamine, dimethylamine, ethylamine, diethylamine, propylamine, dipropylamine, isopropylamine, diisopropylamine, butylamine, dibutylamine, isobutylamine, diisobutylamine, sec.-butylamine, di-sec.-butylamine, hexylamine, dihexylamine, 2-ethylhexylamine, di-(2-ethylhexyl)amine, octylamine, decylamine, dodecylamine, ethanolamine, diethanolamine, isopropanolamine, diisopropanolamine, cyclohexylamine, dicyclohexylamine, N-methylbutylamine, N-ethylbutylamine, N-methyl-cyclohexylamine, N-ethyl-cyclohexylamine, bis-(2-methoxyethyl)amine, pyrrolidine, piperidine, benzylamine, N-methyl-benzylamine, N-isopropylbenzylamine, N-tert.butyl-benzylamine, dibenzylamine, morpholine, 2,6-dimethylmorpholine, bis-(3-dimethylaminopropyl)amine, N-methyl- or N-ethylpiperazine, as well as alkoxylates of primary amines such as 2-(N-ethylamino)ethanol and 2-(N-propylamino)ethanol. Preferred are methylamine, dimethylamine, ethylamine, diethylamine, isopropylamine, diisopropylamine, butylamine, dibutylamine, isobutylamine, diisobutylamine, hexylamine, 2-ethylhexylamine, cyclohexylamine, N-methylcyclohexylamine, N-methyl-benzylamine, N-isopropyl-benzylamine, N-tert.butyl-benzylamine, benzylamine, dibenzylamine, pyrrolidine, piperidine, morpholine and 2,6-dimethylmorpholine. Particularly preferred are methylamine, dimethylamine and especially morpholine.

Another suitable amine C is piperazine. In the case of piperazine, aldehydes ALD are especially produced in the in form of dialdehydes, which can be used in the reaction with, for example, primary diamines, in a 1:2 molar ratio for producing polyamines of Formula (I) with two primary and two secondary amino groups.

Preferably the aldehyde ALD of Formula (III) is selected from the group consisting of 2,2-dimethyl-3-methylamino-propanal, 2,2-dimethyl-3-dimethylamino-propanal, 2,2-dimethyl-3-ethylamino-propanal, 2,2-dimethyl-3-diethylamino-propanal, 2,2-dimethyl-3-bis(2-methoxyethyl)amino-propanal, 2-dimethyl-3-butylamino-propanal, 2,2-dimethyl-3-dibutylamino-propanal, 2,2-dimethyl-3-hexylamino-propanal, 2,2-dimethyl-3-(2-ethylhexyl)amino-propanal, 2,2-dimethyl-3-dodecyclamino-propanal, 2,2-dimethyl-3-(N-pyrrolidino)-propanal, 2,2-dimethyl-3-(N-piperidino)-propanal, 2,2-dimethyl-3-(N-morpholino)-propanal, 2,2-dimethyl-3-bezylamino-propanal, 2,2-dimethyl-3-(N-benzylmethylamino)-propanal, 2,2-dimethyl-3-(N-benzylisopropylamino)-propanal, 2,2-dimethyl-3-cyclohexylamino-propanal, 2,2-dimethyl-3-(N-cyclohexylmethylamino)-propanal and N,N′-bis(2,2-dimethyl-3-oxopropyl)-piperazine.

The polyamines of Formula (I) are new compounds with surprising properties. They are typically liquid and of low viscosity at room temperature, which is highly advantageous for many applications. The term “low viscosity” here indicates viscosity, measured with a cone/plate viscometer at 20° C., of less than 3,000 mPa·s, especially less than 1,500 mPa·s. Nevertheless polyamines of Formula (I) have low volatility and odor, which is otherwise rarely the case for low viscosity polyamines. Furthermore they generally have such a low reactivity toward CO₂ that—in contrast to many polyamines known from the prior art—they do not have a tendency toward formation of crusts or precipitates or viscosity increases. This is a great advantage for many applications.

An additional advantage is the easy availability of the polyamines of Formula (I). Specifically, beginning from commercial primary polyamines and the aldehydes ALD of Formula (III) described, they can be produced in high purity and high yields in a simple process that requires no tedious workup steps. This is possible since the imine formation between the aldehyde ALD and the primary amino groups also proceeds spontaneously without active hydrogen removal and without aminal formation, and hydrogenation is accomplished surprisingly easily despite steric hindrance by the tertiary substituted amino group—even at relatively low hydrogen pressure and relatively low temperature—and the secondary amino groups of the polyamines of Formula (I) formed do not participate in the alkylation reaction, and thus over-alkylation with loss of NH functionality cannot occur.

The high content of amino groups in the form of secondary and optionally tertiary amino groups makes possible a large number of advantageous applications of the polyamines of Formula (I). For example, they can be used wherever low-viscosity, low-odor compounds with several amino groups are desired, for example as a surfactant, dispersant, defoamer, neutralizing agent, anticorrosion agent, antioxidant, complexing agent or catalyst; for example as a constituent of cleaners, fuels, lubricants, asphalts, rubber articles, pharmaceuticals, pesticides, grinding aids, sequestrants, petroleum drilling aids or paper chemicals.

However, the use of polyamines of Formula (I) as curing agents in curable compositions is particularly advantageous. Their compatibility and reactivity with such compositions is surprisingly good. Without limiting the invention in this regard, it is presumed that this can be at least partially attributed to the influence of the secondary or tertiary amino groups located at the ends of the molecules and introduced through the aldehydes ALD of Formula (III) used in the reductive alkylation. In the case of tertiary amino groups, on one hand these can increase the compatibility in curable compositions and on the other hand, have a catalytic effect, and in the case of secondary amino groups the cross-linking density of the plastic formed during the curing of the curable compositions can be increased. As a constituent of curable compositions, the polyamines of Formula (I) provide excellent properties. For example, it is possible with these to Formulate self-leveling epoxy resin compositions which can get by with little or no diluting additives such as solvents, especially benzyl alcohol; which show scarcely any tendency to blushing upon curing; and which give polymer films of excellent visual and mechanical quality. Furthermore, rapidly curing polyurethane and polyurea compositions of high mechanical quality and excellent light stability can be obtained with them—and these have very good processability because of their relatively long pot life. Such rapidly curing compositions have the advantage that they can be further processed very shortly after application.

Particularly suitable curable compositions for use of the polyamines of Formula (I) are those based on polyepoxides (epoxy resins) or polyisocyanates (polyurethanes and polyureas). For example, such curable compositions can be used as hard and soft foams, molding blocks, elastomers, fibers, fiber composites, films or membranes, especially as casting compositions, sealants and adhesives, for example electrical insulating compositions, surface filling compositions, joint sealants, mounting adhesives, auto body adhesives, windshield adhesives, sandwich element adhesives, half-shell adhesives, e.g., for rotor blades of wind turbines, lining adhesives, laminate adhesives or anchoring adhesives, and in particular as linings, coatings, paints, lacquers, sealants, undercoats and primers for construction and industrial applications, for example floor coatings and floor coverings for indoor spaces, such as offices, industrial halls, gymnasia or cold rooms, or outdoors for balconies, terraces, parking decks, bridges or roofs, protective coatings for concrete, cement, metals or plastics, for example for surface sealing of loading docks, tanks, silos, shafts, ductwork or pipelines, wherein these coatings especially protect the respective substrates from corrosion, abrasion, moisture and/or chemicals; and also as base coats, adhesion coats or for making surfaces water repellent.

The polyamines of Formula (I) are therefore advantageously usable in cleaning agents, fuels, lubricants, asphalts, rubber articles, pharmaceuticals, pesticides, grinding aids, sequestrants, petroleum drilling aids, paper chemicals, fiber composites, casting compositions, sealants, adhesives, linings, coatings, paints, lacquers, sealers, primers, base coats, foams, molding blocks, elastomers, fibers, films and membranes.

The polyamines of Formula (I) are particularly suitable on one hand as constituents of compositions based on epoxy resins, especially for surface applications, especially as floor coverings, coatings or paints. The polyamines of Formula (I), as previously mentioned, are low-viscosity substances with low volatility and little odor, which specifically contain secondary amino groups. Through their use as curing agents, the content of primary amino groups in epoxy resin compositions can be kept so low that reactions with CO₂ from air scarcely occur. As a result, blushing effects are largely absent during surface application even under unfavorable reaction conditions, i.e., those that promote blushing, mainly at low curing temperatures, for example in the range of 0 to 10° C., and high humidity. For the use of polyamines of Formula (I) as curing agents for epoxy resin, compositions are available which are largely or completely free from the additives used to reduce blushing according to the prior art, for example benzyl alcohol, and which cure in a reasonable time to form clear, non-tacky films with an attractive surface and high hardness.

The polyamines of Formula (I) are also particularly suitable as constituents of isocyanate group-containing compositions, especially for polyurethane and polyurea coatings. In the curing of polyisocyanates with polyamines, the very high reactivity of the amino groups with isocyanates often leads to problems in processing. With the polyamines of Formula (I), on the other hand, polyurethane and polyurea compositions are available which have low viscosity with little or low solvent content, have scarcely any odor, and have readily manageable reactivity, so that easily processed, rapidly curing coatings with high photostability, good mechanical properties, good adhesion to various substrates and excellent durability can be obtained.

The term “polyurethane” covers all polymers that can be produced according to the so-called diisocyanate polyaddition method. Thus polyurethanes usually have urethane or thiourethane groups and especially also urea groups. The term “polyurethane,” however, also includes polymers that are almost free or completely free from urethane groups. Especially these are so-called polyureas, polyether-polyureas and polyester-polyureas, as well as polyether-polyurethanes, polyester-polyurethanes, polyisocyanurates and polycarbodiimides.

Particularly suitable for use in isocyanate group-containing compositions of polyamines of Formula (I) in which R⁵ does not represent a hydrogen atom, a represents 2 or 3, especially 2, and in which A is free from primary and secondary amino groups. Such polyamines of Formula (I) react relatively slowly with isocyanate groups and are highly compatible with polyurethane and polyurea compositions.

The polyamines of Formula (I) can also be used for producing adducts, wherein at least one amino group of a polyamine of Formula (I) can be reacted with at least one compound that can react with secondary or primary amino groups.

An additional object of the invention is an adduct AD obtained from the reaction of at least one polyamine from Formula (I) with at least one compound VB that bears at least one, preferably at least two, reactive groups RG, wherein the reactive groups RG are selected from the group consisting of isocyanate, isothiocyanate, cyclocarbonate, epoxide, episulfide, aziridine, acrylate, methacrylate, 1-ethinylcarbonyl, 1-propinylcarbonyl, maleimide, citraconimide, vinyl, isopropenyl and allyl groups, as well as substances with more than one of the aforementioned reactive groups. Preferred are isocyanate, epoxide, acrylate, maleimide, vinyl, isopropenyl and allyl groups. Particularly preferred as a reactive group RG are the epoxide group and the isocyanate group.

In these cases, at least one secondary or primary amino group of a polyamine of Formula (I) reacts in an addition reaction with at least one reactive group RG of compound VB to form an adduct AD.

The reaction can either be conducted in such a way that the amino groups of the polyamine of Formula (I) are present in stoichiometric excess relative to the reactive groups RG of the compound VB, wherein adducts AD with at least one, preferably at least two amino groups of Formula (VIII) are available.

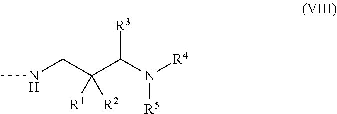

In Formula (VIII), R¹, R², R³, R⁴ and R⁵ have the previously mentioned meanings.

However, the reaction can also be performed in that the reactive groups RG of the compound VB are present in stoichiometric excess relative to the primary and secondary amino groups of the polyamines of Formula (I). In this way adducts AD with at least one, preferably at least two, reactive groups RG can be obtained, as were described previously.

The reaction between the polyamine of Formula (I) and the compound VB to form an adduct AD takes place under known conditions, such as those that are typically used for reactions between the reactive groups RG involved in the respective reaction. The reaction is performed using a solvent or preferably without solvents. Optionally, auxiliaries such as catalysts, initiators or stabilizers may also be used. The reaction with isocyanate groups is preferably performed at room temperature and the reaction with epoxide groups preferably at elevated temperature, preferably at 40 to 100° C.

Examples of suitable compounds VB are
Monomeric and oligomeric polyisocyanates, as well as reaction products of polyisocyanates with polyols having more than one isocyanate group, as mentioned in the following for producing adducts AD1 and AD2;
Polyepoxides such as bis-(2,3-epoxycyclopentyl)ethers, polyglycidyl ethers of polyvalent aliphatic and cycloaliphatic alcohols such as 1,4-butanediol, polypropylene glycols and 2,2-bis-(4-hydroxycyclohexyl)-propane; polyglycidyl ethers of polyvalent phenols such as resorcinol, bis-(4-hydroxyphenyl)-methane (bisphenol F), 2,2-bis-(4-hydroxyphenyl)-propane (bisphenol A), 2,2-bis-(4-hydroxy-3,5-dibromophenyl)-propane, 1,1,2,2-tetrakis-(4-hydroxyphenyl)-ethane, condensation products of phenols with formaldehyde, obtained under acid conditions, such as phenol novolacs and cresol novolacs, as well as polyglycidyl ethers pre-extended with these alcohols and phenols or with polycarboxylic acids such as dimeric fatty acids or a mixture thereof, polyglycidyl esters of polyvalent carboxylic acids such as phthalic acid, terephthalic acid, tetrahydrophthalic acid and hexahydrophthalic acid; N-glycidyl derivatives of amines, amides and heterocyclic nitrogen bases such as N,N-diglycidylaniline, N,N-diglycidyltoluidine, N,N,O-triglycidyl-4-amino-phenol, N,N,N′,N′-tetraglycidyl-bis-(4-aminophenyl)-methane, triglycidyl cyanurate and triglycidyl isocyanurate;
Compounds containing more than one acrylate, methacrylate or acrylamide group, such as tris-(2-hydroxyethyl)-isocyanurate-tri(meth)acrylate, tris-(2-hydroxyethyl) cyanurate-tri-(meth)acrylate, N,N′,N″-tris-(meth)acrylol-perhydrotriazine; acrylates and methacrylates of aliphatic polyethers, polyesters, novolacs, phenols, aliphatic or cycloaliphatic alcohols, glycols and polyester glycols as well as mono- and polyalkoxylated derivatives of the aforementioned compounds, for example ethylene glycol-di-(meth)acrylate, tetraethylene glycol-di(meth)acrylate, polypropylene glycol-di(meth)acrylate, 1,4,butanediol-di-(meth)acrylate, 1,6-hexanediol-di(meth)acrylate, neopentyl glycol-di-(meth)acrylate, trimethylolpropane tri(meth)acrylate, pentaerythritol-tetra(meth)acrylate, dipentaerythritol-penta(meth)acrylate, dipentaerythritol-hexa(meth)acrylate; acrylate- or methacrylate-functional polybutadienes, polyisoprenes or block copolymers thereof; adducts of polyepoxides such as the above-mentioned epoxides with acrylic and methacrylic acid; polyurethane(meth)acrylates; acrylamides such as N,N′-methylene-bis-acrylamide;
Compounds having more than one 1-ethinylcarbonyl or 1-propinylcarbonyl group;
Compounds having more than one maleimide or citraconimide group;
Compounds having more than one vinyl and/or isopropenyl group;
Compounds having more than one allyl group;
And heterofunctional compounds, i.e., those having at least two different ones of the aforementioned reactive groups.

Particularly suitable as the compound VS are on one hand monomeric and oligomeric polyisocyanates and reaction products of polyisocyanates with polyols containing more than one isocyanate group and on the other hand polyepoxides.

The adducts AD are suitable for the same uses as the polyamines of Formula (I).

Especially adducts AD which have amino groups of Formula (VIII) are suitable for the same applications as the polyamines of Formula (I), especially as curing agents in curable compositions. However, adducts AD which have the reactive groups RG described are also suitable as constituents of curable compositions.

Among the adducts AD described, of particular interest are adducts in an embodiment containing at least two amino groups of Formula (VIII), denoted in the following as adducts AD1. Preferred additives AD1 are derived from polyisocyanates as compound VB.

Particularly interesting among the adducts AD described in an additional embodiment are adducts AD2 containing at least two isocyanate groups, for the manufacturing of which a polyisocyanate was used as the compound VB.

Particularly suitable polyisocyanates for producing the adducts AD2 and the preferred adducts AD1 are mono- and/or oligomeric aliphatic, cycloaliphatic, arylaliphatic or aromatic polyisocyanates such as 1,4-tetramethylene diisocyanate, 1,6-hexamethylene diisocyanate (HDI), 2-methylpentamethylene-1,5-diisocyanate, 2,2,4- and 2,4,4-trimethyl-1,6-hexamethylene diisocyanate (TMDI), 1,10-decamethylene diisocyanate, 1,12-dodecamethylene diisocyanate, lysine and lysine ester diisocyanate, cyclohexane-1,3- and -1,4-diisocyanate and arbitrary mixtures of these isomers, 1-methyl-2,4- and -2,6-diisocyanatocyclohexane and arbitrary mixtures of these isomers (HTDI), 1-isocyanato-3,3,5-trimethyl-5-isocyanatomethyl cyclohexane (=isophorone diisocyanate or IPDI), perhydro-2,4,- and -4,4,-diphenylmethane diisocyanate (HMDI), 1,4-diisocyanato-2,2,6-trimethylcyclohexane (TMCDI), 1,3- and 1,4-bis-(isocyanatomethyl)-cyclohexane, m- and p-xylylene diisocyanate (m- and p-XDI), 1,3,5-tris-(isocyanatomethyl)-benzene, and p-tetramethyl-1,3- and -1,4-xylylene diisocyanate (m- and p-TMXDI), bis-(1-isocyanato-1-methylethyl)-naphthalene, dimeric and trimeric fatty acid isocyanates such as 3,6-bis-(9-isocyanatononyl)-4,5-di-(1-heptenyl)-cyclohexene (dimeryl diisocyanate), α,α,α′,α′,α″,α″-hexamethyl-1,3,5-mesitylene triisocyanate, 2,4- and 2,6-toluoylene diisocyanate and arbitrary mixtures of these isomers (TDI), 4,4,-, 2,4′- and 2,2′-diphenylmethane diisocyanate and arbitrary mixtures of these isomers (MDI), mixtures of MDI and MDI homologs (polymeric MDI or PMDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), dianisidine diisocyanate (DADI), tris-(4-isocyanatophenyl)-methane, tris-(4-isocyanatophenyl)-thiophosphate; oligomers of these isocyanates containing uretdione, isocyanurate or iminoooxadiazinedione groups; modified polyisocyanates containing ester, urea, urethane, biuret, allophanate, carbodiimide, uretoneimine or oxadiazinetrione groups; as well as isocyanate-containing polyurethane polymers, i.e., reaction products of polyisocyanates containing more than one isocyanate group with substances containing two or more hydroxyl groups (so-called “polyols”), such as divalent or multivalent alcohols, glycols or amino alcohols, polyhydroxy-functional polyethers, polyesters, polyacrylates, polycarbonates or polyhydrocarbons, especially polyethers.

The adducts AD1 are especially suitable as curing agents in isocyanate group-containing compositions. They have a readily manageable viscosity. This is unexpected, especially for adducts based on polyisocyanates as compound VB. Specifically, if polyamines known from the prior art are adducted with polyisocyanates in the manner described, numerous problems can result. In the case of polyamines with mainly primary amino groups, the reactivity with polyisocyanates is usually so high that the reaction proceeds uncontrolled, and despite inherently suitable stoichiometry, very high viscosities or even solids can form. However, even in the case of relatively slow secondary polyamines, it is often difficult to obtain adducts with manageable viscosities. The relatively low viscosity of the adducts AD1 is possibly attributable to the amino groups originating from the aldehyde ALD, which are bound to the substituents of the urea groups formed, since these act as a kind of internal solvent. The adducts AD1 as curing agents are highly compatible with isocyanate group-containing compositions. Such compositions have a relatively long pot life, in a range similar to that of the compositions with the corresponding polyamines of Formula (I) as curing agents. Use of the adducts AD1 also provides the opportunity to increase the volume and weight fractions of the curing agent in the composition, which may be highly desirable in the case of two-component application to achieve a desired mixing ratio between the two components. In addition, the curing of such compositions to form a plastic takes place even more rapidly if an adduct AD1 is present as the curing agent rather than a polyamine of Formula (I), since some of the reactions necessary for curing have already taken place prior to production of the adduct. Therefore such compositions can be worked even sooner after application.

The adducts AD2 are especially suitable as polyisocyanates for Formulating polyurethane and polyurea coatings. They exhibit the great advantage that their isocyanate groups are stable in the presence of the urea groups originating from the adducting, as long as moisture is absent, which is often not the case when polyamines from the prior art are used. The adducts AD2 also have a relatively low viscosity, which makes their use for Formulating polyurethane and polyurea coatings particularly attractive. The use of the adducts AD2 in polyurethane and polyurea compositions likewise exhibits the advantage that in this way a polyamine of Formula (I) in fully reacted form is used as a constituent of the curable composition, which in turn results in very rapid curing and substantially facilitates the establishment of a desired mixing ratio of a two-component composition.

Polyamines of Formula (I) that contain primary amino groups can be reacted with Michael acceptors such as maleic acid diesters, fumaric acid diesters, citraconic acid diesters, acrylic acid esters, methacrylic acid esters, cinnamic acid esters, itaconic acid diesters, vinylphosphonic acid diesters, vinylsulfonic acid aryl esters, vinyl sulfones, vinyl nitriles, 1-nitroethylenes or Knoevenagel condensation products such as those from malonic acid diesters and aldehydes such as formaldehyde, acetaldehyde or benzaldehyde, wherein the reaction products formed have a reduced content of primary amino groups or are completely free from primary amino groups. It is therefore conceivable, for example, to react a primary aliphatic diamine with a substoichiometric quantity of aldehyde ALD in a reductive alkylation as previously described and then to react some or all of the remaining primary amino groups with one of the Michael acceptors mentioned.

Additional objects of the invention are curable compositions containing at least one polyamine of Formula (I). Preferably, such a curable composition contains epoxy groups and/or isocyanate groups.

An additional object of the invention is a curable composition in the form of an isocyanate group-containing composition Z1, containing

a) at least one polyisocyanate, and

b) at least one curing agent compound HV, which has at least two reactive groups selected from the group consisting of primary amino groups, secondary amino groups, hydroxyl groups and mercapto groups;

with the specification that the polyisocyanate and/or the curing agent compound HV is a compound selected from the group consisting of the polyamines of Formula (I), the adducts AD1 and the adducts AD2.

The term “polyisocyanate” covers compounds with two or more isocyanate groups, regardless whether they are monomeric di- or triisocyanates, oligomeric diisocyanates or isocyanate group-containing adducts and polymers.

In one embodiment, a suitable polyisocyanate is an adduct AD2 which has at least two isocyanate groups, as described above.

In an additional embodiment, a suitable polyisocyanate is a polyurethane polymer PUP containing isocyanate groups.

A suitable polyurethane polymer PUP is especially obtainable from the reaction of at least one polyol with at least one polyisocyanate. This reaction can take place in that the polyol and the polyisocyanate are made to react by the usual methods, at temperatures of 50° C. to 100° C., optionally using suitable catalysts, wherein the polyisocyanate is used in such a quantity that the isocyanate groups thereof are present in stoichiometric excess relative to the hydroxyl groups of the polyol. Advantageously, the polyisocyanate is used in such a quantity so that an NCO/OH ratio of 1.3 to 25, especially a ratio of 1.5 to 15, is maintained. The “NCO/OH ratio” is defined as the ratio of the number of isocyanate groups used to the number of hydroxyl groups used. Preferably after the reaction of all hydroxyl groups in the polyol, a free isocyanate group content of 0.5 to 30 wt.-%, particularly preferably of 0.5 to 25 wt.-%, remains in the polyurethane polymer PUP.

Optionally the polyurethane polymer PUP can be prepared using plasticizers, wherein the plasticizers used contain no groups reactive toward isocyanates.

As polyols for the preparation of a polyurethane polymer PUP, especially the following commercially available polyols or mixtures thereof are used:
Polyoxyalkylene polyols, also known as polyether polyols or oligoetherols, which are polymerization products of ethylene oxide, 1,2-propylene oxide, 1,2- or 2,3-butylene oxide, oxetane, tetrahydrofuran or mixtures thereof, possibly polymerized with the aid of a initiator molecule with two or more active hydrogen atoms such as water, ammonia or compounds with several OH or NH groups such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylol-ethane, 1,1,1-trimethylol-propane, glycerol, aniline, as well as mixtures of the aforementioned compounds. It is also possible to use both polyoxyalkylenepolyols that have a low degree of unsaturation (measured according to ASTM D-2849-69 and given in milliequivalents of unsaturation per gram polyol (mEq/g)), produced for example with the aid of so-called Double Metal Cyanide complex catalysts (DMC catalysts), and polyoxyalkylene polyols with a higher degree of unsaturation, produced for example with the aid of anionic catalysts such as NaOH, KOH, CsOH or alkali alcoholates.

Particularly suitable are polyoxyalkylenediols or polyoxyalkylenetriols, especially polyoxyethylene and polyoxypropylenedi- and -triols.

Especially suitable are polyoxyalkylenediols and -triols with a degree of unsaturation of less than 0.02 mEq/g and with a molecular weight in the range of 1,000-30,000 g/mol, as well as polyoxypropylene diols and triols with a molecular weight of 400-8,000 g/mol.

Also especially suitable are so-called ethylene oxide-terminated (“EO-endcapped”, ethylene oxide-endcapped) polyoxypropylene polyols. The latter are especially polyoxypropylene-polyoxyethylenepolyols, which for example are obtained in that pure polyoxypropylene polyols, especially polyoxypropylene diols and triols, are further alkoxylated with ethylene oxide after the polypropoxylation reaction is complete and thus contain primary hydroxyl groups.
Styrene-acrylonitrile or acrylonitrile-methyl methacrylate-grafted polyether polyols.
Polyesterpolyols, also known as oligoesterols, produced according to known methods, especially the polycondensation of hydroxycarboxylic acids or the polycondensation of aliphatic and/or aromatic polycarboxylic acids with divalent or polyvalent alcohols.

Especially suitable as polyester polyols are those produced from di- to trivalent, especially divalent, alcohols, such as ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid diol (dimer diol), hydroxypivalic acid neopentyl glycol ester, glycerol, 1,1,1-trimethylolpropane or mixtures of the aforementioned alcohols, with organic di- or tricarboxylic acid esters, especially dicarboxylic acid esters, or anhydrides or esters thereof; such as succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethylterephthalate, hexahydrophthalic acid, trimellitic acid and T trimellitic acid anhydride, or mixtures of the aforementioned acids, as well as polyesterpolyols from lactones such as □-caprolactone and initiators such as the aforementioned di- or trivalent alcohols.

Especially suitable polyester polyols are polyesterdiols.
Polycarbonate polyols, such as those that can be obtained by reacting for example the above-mentioned alcohols—used for building the polyester polyols—with dialkyl carbonates, diaryl carbonates or phosgene.
Block copolymers having at least two hydroxyl groups, which have at least two different blocks with polyether, polyester and/or polycarbonate structures of the type described in the preceding, especially polyether polyester polyols.
Polyacrylate and polymethacrylate polyols.
Polyhydroxy-functional fats and oils, for example natural fats and oils, especially castor oil, or polyols obtained by chemical modification of natural fats and oils—so-called oleochemical polyols—for example the epoxy-polyesters or epoxy-polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradative processes such as alcoholysis or ozonolysis and subsequent chemical linking, for example by ester exchange or dimerization, of the degradation products or derivatives thereof obtained in this way. Especially suitable degradation products of natural fats and oils are fatty acids and fatty alcohols as well as fatty acid esters, especially the methyl esters (FAME), which can be derivatized for example by hydroformylation and hydrogenation to hydroxy fatty acid esters.
Polyhydrocarbon polyols, also called oligohydrocarbonols, such as polyhydroxyfunctional polyolefins, polyisobutylenes, polyisoprenes; polyhydroxyfunctional ethylene-propylene-, ethylene-butylene or ethylene-propylene-diene copolymers, such as those manufactured for example by the firm of Kraton Polymers; polyhydroxyfunctional polymers of dienes, especially of 1,3-butadiene, which in particular can also be produced by anionic polymerization; polyhydroxyfunctional copolymers from dienes such as 1,3-butadiene or diene mixtures and vinyl monomers such as styrene, acrylonitrile, vinyl chloride, vinyl acetate, vinyl alcohol, isobutylene and isoprene, for example polyhydroxyfunctional acrylonitrile/butadiene-copolymers, for example such as can be produced from epoxides or amino alcohols and carboxyl-terminated acrylonitrile/butadiene-copolymers (for example, commercially available under the name of Hypro® (previously Hycar®) CTBN and CTBNX and ETBN from Nanoresins AG, Germany, or Emerald Performance Materials LLC); as well as hydrogenated polyhydroxyfunctional polymers or copolymers of dienes.

These polyols named preferably have a mean molecular weight of 250-30,000 g/mol, especially of 400-20,000 g/mol, and preferably have a mean OH functionality in the range of 1.6 to 3.

Preferred polyols are polyether, polyester, polycarbonate and polyacrylate polyols, preferably diols and triols. Especially preferred are polyether polyols, especially polyoxypropylene and polyoxypropylene-polyoxyethylene polyols, as well as liquid polyester polyols and polyether-polyester polyols.

In addition to these polyols mentioned, small amounts of low molecular weight di- or polyvalent alcohols such as 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher-valence alcohols, low molecular weight alkoxylation products of the aforementioned di- and polyvalent alcohols, as well as mixtures of the aforementioned alcohols are also used concomitantly in the manufacturing of the polyurethane polymers PUP. In addition, small amounts of polyols with a mean OH functionality of more than 3, for example sugar polyols, can be used concomitantly.

As polyisocyanates for producing an isocyanate group-containing polyurethane polymer PUP, aromatic or aliphatic polyisocyanates, especially the diisocyanates, are used.

Particularly suitable aromatic polyisocyanates are monomeric di- or triisocyanates such as 2,4- and 2,6-toluoylenediisocyanates and arbitrary mixtures of these isomers (TDI), 4,4,-, 2,4′- and 2,2′-diphenylmethane diisocyanates and arbitrary mixtures of these isomers (MDI), mixtures of MDI and MDI homologs (polymeric MDI or PMDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatodiphenyl (TODI), dianisidine diisocyanate (DADI), tris-(4-isocyanatophenyl)-methane, tris-(4-isocyanatophenyl)thiophosphate, as well as arbitrary mixtures of the aforementioned Isocyanates. Preferred are MDI and TDI. In the case of MDI in particular 2,4′-diphenylmethane diisocyanate is also preferred.

Particularly suitable aliphatic polyisocyanates are monomeric di- or triisocyanates such as 1,4-tetramethylene-diisocyanate, 2-methyl-pentamethylene-1,5-diisocyanate, 1,6-hexamethylene-diisocyanate (HDI), 2,2,4- and 2,4,4-trimethyl-1,6-hexamethylene-diisocyanate (TMDI), 1,10-decamethylene-diisocyanate, 1,12-dodecamethylene-diisocyanate, lysine and lysine ester diisocyanates, cyclohexane-1,3- and -1,4-diisocyanates, 1-methyl-2,4- and -2,6-diisocyanato-cyclohexane and arbitrary mixtures of these isomers (HTDI or H₆TDI), 1-isocyanato-3,3,5-trimethyl-5-isocyanatomethyl-cyclohexane (=isophorone diisocyanate or IPDI), perhydro-2,4′- and -4,4′-diphenylmethane-diisocyanate (HMDI or H₁₂MDI), 1,4-diisocyanato-2,2,6-trimethylcyclohexane (TMCDI), 1,3- and 1,4-bis-(isocyanatomethyl)-cyclohexane, m- and p-xylylene diisocyanate (m- and p-XDI), m- and p-tetramethyl-1,3- and -1,4-xylylene diisocyanate (m- and p-TMXDI), 1,3,5-tris-(isocyanatomethyl)-benzene, bis-(1-isocyanato-1-methylethyl)-naphthalene, dimeric and trimeric fatty acid isocyanates such as 3,6-bis-(9-isocyanatononyl)-4,5-di-(1-heptenyl)-cyclohexene (dimeryl diisocyanate), α,α,α′,α′,α″,α″-hexamethyl-1,3,5-mesitylene triisocyanate, as well as arbitrary mixtures of the aforementioned Isocyanates. HDI and IPDI are preferred.

In an additional embodiment a suitable polyisocyanate is a polyisocyanate PI in the form of a monomeric di- or triisocyanate or of an oligomer of a monomeric diisocyanate or of a derivative of a monomeric diisocyanate, wherein as the monomeric di- or triisocyanate especially the aforementioned aromatic and aliphatic di- and triisocyanates are suitable.

Especially suitable as polyisocyanates PI are oligomers or derivatives of monomeric diisocyanates, especially of HDI, IPDI, TDI and MDI. Commercially available types are especially HDI biurets, for example as Desmodur® N 100 and N 3200 (from Bayer), Tolonate® HDB and HDB-LV (from Rhodia) and Duranate® 24A-100 (from Asahi Kasei); HDI isocyanurates, for example as Desmodur® N 3300, N 3600 and N 3790 BA (all from Bayer), Tolonate® HDT, HDT-LV and HDT-LV2 (from Rhodia), Duranate® TPA-100 and THA-100 (from Asahi Kasei) and Coronate® HX (from Nippon Polyurethane); HDI-uretdiones, for example as Desmodur®N 3400 (from Bayer); HDI-iminooxadiazinediones, for example as Desmodur® XP 2410 (from Bayer); HDI-allophanates, for example as Desmodur® VP LS 2102 (from Bayer); IPDI-isocyanurates, for example in solution as Desmodur® Z 4470 (from Bayer) or in solid form as Vestanat® T1890/100 (from Degussa); TDI oligomers, for example as Desmodur® IL (from Bayer); as well as mixed isocyanurates on the basis of TDI/HDI, for example as Desmodur® HL (from Bayer). Also especially suitable are forms of MDI liquid at room temperature (so-called “modified MDI”), which are mixtures of MDI with MDI derivatives, such as MDI carbodiimides or MDI uretoneimines or MDT urethanes, known for example under trade names such as Desmodur® CD, Desmodur® PF, Desmodur® PC (all from Bayer) and Isonate® 143L (from Dow) as well as mixtures of MDI and MDI homologs (polymeric MDI or PMDI), available under trade names such as Desmodur® VL, Desmodur® VL50, Desmodur® VL R10, Desmodur® VL R20 and Desmodur® VKS 20F (all from Bayer), Isonate® M 309, Voranate® M 229 and Voranate® M 580 (all from Dow) or Lupranate® M 10 R (from BASF).

The aforementioned oligomeric polyisocyanates PI in practice are usually mixtures of substances with different degrees of oligomerization and/or chemical structures. Preferably they have a mean NCO functionality of 2.1 to 4.0 and contain especially isocyanurate, iminooxadiazinedione, uretdione, urethane, biuret, allophanate, carbodiimide, uretoneimine or oxadiazinetrione groups.

Preferred polyisocyanates PI are forms of MDI liquid at room temperature, as well as the oligomers of HDI, IPDI and TDI, especially the isocyanurates and the biurets.

Additional suitable polyisocyanates are mixtures of at least one adduct AD2 and/or at least one polyurethane polymer PUP and/or at least one polyisocyanate PI, as described in the preceding.

Especially suitable as polyisocyanates are so-called quasi-prepolymers. These are either a polyurethane polymer PUP, to produce which at least one polyol was reacted with a relatively large excess of at least one monomeric diisocyanate; or a reaction product of at least one polyamine with a relatively large excess of at least one monomeric diisocyanate. Polyoxyalkylene diamines and polyoxyalkylene triamines are especially suitable as polyamines for this purpose.

Such quasi-prepolymers are commercially available, for example, as Suprasec® 1007, Suprasec® 2008, Suprasec® 2021, Suprasec® 2029, Suprasec® 2054, Suprasec® 2058, Suprasec® 2067, Suprasec® 2234, Suprasec® 2444, Suprasec® 2445, Suprasec® 2783, Suprasec® 2980, Suprasec® 2982, Suprasec® 9603, Suprasec® 9608, Suprasec® 9616, Rubinate® 1209, Rubinate® 1790, Rubinate® 9009, Rubinate® 9271, Rubinate® 9447, Rubinate® 9480 and Rubinate® 9495 (from Huntsman); or as Desmodur® E 23, Desmodur® E 210 and Desmodur® E 743 (from Bayer); or as Echelon® MP 100, Echelon® MP 101, Echelon® MP 102, Echelon® MP 104, Echelon® MP 106, Echelon® MP 107, Echelon® MP 108 and Echelon® MC 400 (from Dow); or as Lupranate® 279, Lupranate® 5060 and Lupranate® 5080 (from BASF).

Quasi-prepolymers on the basis of MDI preferably contain an increased fraction of 2,4′-MDI. Such quasi-prepolymers are characterized by a lower reactivity than especially those on the basis of 4,4′-MDI.

The polyisocyanates can especially represent a mixture of at least one polyisocyanate PI and at least one adduct AD2.

Suitable curing agent compounds HV in one embodiment are the previously described polyamines of Formula (I). Preferred are polyamines of Formula (I) in which R⁵ does not represent a hydrogen atom, and in which a represents 2 or 3, especially 2, and in which A contains no primary or secondary amino groups.

In an additional embodiment suitable curing agent compounds HV are the previously described adducts AD1. Preferred adducts AD1 are derived from at least one polyisocyanate as compound VB.

Additional suitable curing agent compounds HV are polyamines and amino alcohols, especially the following:
The previously described amines PA of Formula (II);
Secondary aliphatic polyamines such as especially N,N′-dibutyl-ethylenediamine; N,N′-di-tert.butyl-ethylenediamine, N,N′-diethyl-1,6-hexanediamine, 1-(1-methylethyl-amino)-3-(1-methylethyl-aminomethyl)-3,5,5-trimethylcyclohexane (Jefflink® 754 from Huntsman), N⁴-cyclohexyl-2-methyl-N²-(2-methylpropyl)-2,4-pentanediamine, N,N′-dialkyl-1,3-xylylenediamine, bis-(4-(N-alkylamino)-cyclohexyl)-methane, N-alkylated polyether amines, for example the Jeffamine®-Types SD-231, SD-401, ST-404 and SD-2001 (from Huntsman), products from the Michael-like addition reaction of primary aliphatic polyamines with Michael acceptors such as maleic acid diester, fumaric acid diester, citraconic acid diester, acrylic acid ester, methacrylic acid ester, cinnamic acid ester, itaconic acid diester, vinyl phosphonic acid diester, vinylsulfonic acid aryl ester, vinyl sulfone, vinyl nitrile, 1-nitroethylene or Knoevenagel condensation products such as those from malonic acid diesters and aldehydes such as formaldehyde, acetaldehyde or benzaldehyde, as well as commercial secondary aliphatic polyamines such as Gaskamine® 240 (from Mitsubishi) or the Desmophen® types NH 1220, NH 1420 and NH 1520 (from Bayer);
Primary and/or secondary aromatic polyamines, such as especially m- and p-phenylenediamine, 4,4′-, 2,4′ and 2,2′-diaminodiphenylmethane, 3,3′-dichloro-4,4′-diaminodiphenylmethane (MOCA), 2,4- and 2,6-toluoylene diamine, mixtures of 3,5-dimethylthio-2,4- and -2,6-toluoylenediamine (available as Ethacure® 300 from Albemarle), mixtures of 3,5-diethyl-2,4- and -2,6-toluoylenediamine (DETDA), 3,3′,5,5′-tetraethyl-4,4′-diaminodiphenylmethane (M-DEA), 3,3′,5,5′-tetraethyl-2,2′-dichloro-4,4′-diaminodiphenylmethane (M-CDEA), 3,3′-diisopropyl-5,5′-dimethyl-4,4′-diaminodiphenylmethane (M-MIPA), 3,3′,5,5′-tetraisopropyl-4,4′-diaminodiphenylmethane (M-DIPA), 4,4′-diaminodiphenylsulfone (DDS), 4-amino-N-(4-aminophenyl)-benzenesulfonamide, 5,5′-methylenedianthranilic acid, dimethyl-(5,5′-methylenedianthranilate), 1,3-propylene-bis-(4-aminobenzoate), 1,4-butylene-bis-(4-aminobenzoate), polytetramethylene oxide-bis-(4-aminobenzoate) (available as Versalink® from Air Products), 1,2-bis-(2-aminophenylthio)-ethane, N,N′-dialkyl-p-phenylenediamine such as Unilink® 4100 (from UOP), N,N′-dialkyl-4,4′-diaminodiphenylmethane such as Unilink® 4200 (from UOP), 2-methylpropyl-(4-chloro-3,5-diaminobenzoate) and tert.butyl-(4-chloro-3,5-diaminobenzoate);
Amino alcohols such as especially diethanolamine, diisopropanolamine, 3-methylamino-1,2-propanediol, 2-(methylamino)ethanol, 2-(ethylamino)ethanol, 2-(butylamino)ethanol, 2-(cyclohexylamino)ethanol, 3-pyrrolidinol, 3- or 4-hydroxy-piperidine, 2-piperidine-ethanol, 2-[2-(1-piperazyl)]ethanol, 2-[2-(1-piperazyl)ethoxy]ethanol and N-hydroxyethylaniline.

Also suitable as curing agent compounds HV are commercially available polyols, especially the polyols mentioned in the preceding for producing the polyurethane polymers PUP described, low molecular weight di- or polyvalent alcohols and low molecular weight alkoxylation products of these alcohols.

Additionally suitable as curing agent compounds HV are polythiols, especially the mercaptan group-containing compounds mentioned in the following as possible constituents of an epoxy resin composition Z2.

Preferably the isocyanate group-containing composition Z1 has at least one polyoxyalkylene compound, especially preferably at least one polyoxypropylene compound, in the form of either a polyoxyalkylene diamine or a polyoxyalkylene triamine—optionally in the form of a polyamine of Formula (I)—or in the form of a polyoxyalkylene dial or of a polyoxyalkylene triol or in the form of a polyisocyanate P, which is a reaction product between one of the polyoxyalkylene compounds mentioned and a polyisocyanate. In the fully cured state, such compositions Z1 have especially high ductility and elasticity.

Preferably the isocyanate group-containing composition Z1 contains at least one compound that has a functionality >2 with respect to isocyanate groups, primary amino groups, secondary amino groups, hydroxyl groups or mercapto groups, i.e., has more than two of the reactive groups mentioned. Possible compounds with a functionality >2 are an adduct AD2, a polyisocyanate P or a curing agent compound HV, especially a triamine or a triol.

Preferably the mean functionality of the first, isocyanate group-containing component is a two-component composition Z1 in the range of 1.9 to 3.0, especially preferably in the range of 2.0 to 2.5.

Preferably the mean functionality of the second, isocyanate group-free component of a two-component composition Z1 is in the range of 1.9 to 3.0, especially preferably in the range of 2.0 to 2.5.

Preferably one of the two components of a two-component composition Z1 has a functionality of about 2.

The isocyanate group-containing composition Z1 optionally contains at least one catalyst. Suitable catalysts are on one hand nitrogen-containing compounds, especially tertiary amines and amidines, such as especially N-ethyl-diisopropylamine, N,N,N′,N′-tetramethyl-alkylenediamine, bis-(N,N-diethylaminoethyl)-adipate, N,N,N-tris-(3-dimethylaminopropyl)-amine, 1,4-diazabicyclo[2.2.2]-octane (DABCO), 1,8-diazabicyclo-[5.4.0]undec-7-ene (DBU), 1,5-Diazabicyclo[4.3.0]non-5-ene (DBN), N-alkylmorpholines such as N-methylmorpholine and N-ethylmorpholine, N,N′-dimethylpiperazine, benzyldimethylamine, N,N-cyclohexylamine, N,N,N′,N″,N″-pentamethyl-diethylenetriamine, N,N,N′,N″,N″-pentamethyl-dipropylenetriamine, N-(3-dimethylaminopropyl)-N,N-diisopropanolamine, N′-(3-(dimethylamino)propyl)-N,N-dimethyl-1,3-propanediamine, 1-methyl-4-(2-dimethylaminoethyl)piperazine, 1,3,5-tris-(3-(dimethylamino)propyl)-hexahydro-s-triazine; nitrogen-aromatic compounds such as especially 4-dimethylaminopyridine, N-methylimidazole, N-vinylimidazole or 1,2-dimethylimidazole; organic ammonium compounds or alkoxylated tertiary amines.

Also suitable as catalysts are metal compounds, especially tin compounds such as particularly dibutyltin dichloride, dibutyltin oxide, dibutyltin diacetate, dibutyltin dilaurate, dibutyltin diacetylacetonate, other dibutyltin dicarboxylates, dioctyltin dicarboxylates such as especially dioctyltin dilaurate, monobutyltin trichloride, tin(II)-octoate and alkyltin thioester; bismuth compounds such as bismuth trioctoate and bismuth tris(neodecanoate); as well as compounds of zinc, manganese, iron, chromium, cobalt, copper, nickel, molybdenum, lead, cadmium, mercury, antimony, vanadium, titanium, zirconium or potassium.

Also suitable as catalysts are combinations of the compounds mentioned, especially of metal compounds and nitrogen-containing compounds.

Optionally the isocyanate group-containing composition Z1 has additional constituents, especially auxiliaries and additives usually used in polyurethanes, for example the following:
Plasticizers, especially carboxylic acid esters such as phthalates, especially dioctyl phthalate, diisononyl phthalate or diisodecyl phthalate, adipates, especially dioctyl adipate, azelates and sebacates, organic phosphoric and sulfonic acid esters or polybutenes;
Reactive diluents and crosslinking agents, for example natural resins, fats or oils such as colophonium, shellac, linseed oil, castor oil and soybean oil, also latent curing agents such as aldimines, ketimines, enamines and oxazolidines derived from polyamines;
Nonreactive thermoplastic polymers, such as homo- or copolymers of unsaturated monomers, especially from the group comprising ethylene, propylene, butylene, isobutylene, isoprene, vinyl acetate and alkyl(meth)acrylates, especially polyethylene (PE), polypropylene (PP), polyisobutylene, [and] ethylene-vinyl acetate copolymers (EVA) and atactic poly-α-olefins (APAO);
Solvents, for example ketones such as acetone, methylethylketone, diisobutyl ketone, acetylacetone, mesityl oxide, cyclohexanone, methylcyclohexanone; acetates such as ethyl acetate, propyl acetate, butyl acetate, formates, propionates and malonates such as diethyl malonate; ethers such as dialkyl ether, ketone ethers and ester ethers, for example diisopropyl ether, diethyl ether, dibutyl ether, diethylene glycol diethyl ether and ethylene glycol diethyl ether; aliphatic and aromatic hydrocarbons such as toluene, xylene, diisopropylnaphthalene, heptane, octane and petroleum fractions such as naphtha, White Spirit, petroleum ether and gasoline, for example Solvesso® types (from Exxon), halogenated hydrocarbons such as methylene chloride as well as N-alkylated lactams such as N-methylpyrrolidone;
Inorganic and organic fillers, especially ground or precipitated calcium carbonates, which are optionally coated with fatty acids, especially stearates, barytes (heavy spar), talc, quartz flour, quartz sand, dolomite, wollastonite, kaolin, calcined kaolin, mica (potassium-aluminum silicate), molecular sieves, aluminum oxide, aluminum hydroxide, magnesium hydroxide, silicas including highly dispersed silicas from pyrolysis processes, carbon blacks including industrially manufactured carbon blacks, graphite, powdered metals such as aluminum, copper, iron, silver or steel, PVC powder or hollow spheres;
Fibers, especially glass fibers, carbon fibers, metal fibers, ceramic fibers or plastic fibers such as polyamide fibers or polyethylene fibers;
Pigments, for example titanium dioxide or iron oxide;
Rheology modifiers, such as especially thickeners, for example phyllosilicates such as bentonite, derivatives of castor oil, hydrogenated castor oil, polyamides, polyurethanes, urea compounds, pyrogenic silicas, cellulose ethers and hydrophobically modified polyoxyethylene;
Drying agents, such as especially molecular sieves, calcium oxide, highly reactive isocyanates such as p-tosylisocyanate, orthoformic acid esters, alkoxysilanes such as tetraethoxysilane, organoalkoxysilanes such as vinyl trimethoxysilane, and organoalkoxysilanes, that have a functional group in α-position relative to the silane group;
Adhesion enhancers, for example organoalkoxysilanes such as aminosilanes, mercaptosilanes, epoxysilanes, vinylsilanes, (meth)acrylsilanes, isocyanatosilanes, carbamatosilanes, alkylsilanes, S-(alkylcarbonyl)-mercaptosilanes and aldiminosilanes, as well as oligomeric forms of these silanes, especially 3-glycidoxypropyl-trimethoxysilane, 3-aminopropyl-trimethoxysilane, N-(2-aminoethyl)-3-aminopropyl-trimethoxysilane, N-(2-aminoethyl)-N-[3-(trimethoxysilyl)propyl]-ethylenediamine, 3-mercaptopropyl-trimethoxysilane, 3-isocyanatopropyl-trimethoxysilane, 3-ureidopropyl-trimethoxysilane, 3-chloropropyl-trimethoxysilane, vinyl-trimethoxysilane, or the corresponding organosilanes with ethoxy groups in place of the methoxy groups;
Stabilizers against oxidation, heat, light and UV radiation;
Flame-retardant substances, such as are mentioned in the following as possible constituents of an epoxy resin composition Z2;
Surface-active substances, such as wetting agents, leveling agents, deaerators or defoamers; and
Biocides, such as algicides, fungicides or fungal growth inhibiting substances.

Preferably the isocyanate group-containing composition Z1 has additional auxiliaries and additives, especially fillers, pigments and stabilizers.

Preferably the isocyanate group-containing composition Z1 has only a small fraction of catalyst, especially metal-containing catalyst content of less than 0.02 wt.-% metal. Especially preferably it is essentially free of catalysts added to increase the curing speed, especially organometallic compounds such as dibutyltin dilaurate and similar organotin compounds.

Preferably the isocyanate group-containing composition Z1 has only a small fraction of solvent, particularly preferably less than 10 wt.-%, especially less than 5 wt.-% of solvent. Most preferably the isocyanate group-containing composition Z1 is essentially free of solvents.

The isocyanate group-containing composition Z1 is preferably in the form of a two-component composition.

The term “two-component” is applied to a curable composition in which the constituents of the curable composition are present in two separate components, each of which is stored in its own container. The two components are not mixed together until just before or during the application of the curable composition, after which the mixed composition is cured, optionally under the influence of moisture.

A two-component composition Z1 consists of a first, isocyanate group-containing component, which contains at least one polyisocyanate, optionally in the form of an adduct AD2, and a second, isocyanate group-free component that has at least one curing agent compound HV, optionally in the form of a polyamine of Formula (I) or of an adduct AD1. Additional constituents of the composition Z1, for example catalysts or the auxiliaries and additives mentioned, can be present as a constituent of the first component or as a constituent of the second component. It is advantageous to make sure that additional constituents do not greatly detract from the shelf life of the respective component, i.e., these constituents must not trigger the reactions leading to curing during storage to a significant degree. This especially means that substances which are used as a constituent of the first isocyanate group-containing component should contain no water, or at most traces. It may be reasonable to dry certain constituents before mixing into the composition.

The production of the two components is performed separately and, at least for the first, isocyanate group-containing component, is performed under exclusion of moisture. The two components separately from one another are storage-stable, i.e., they can each be stored in a suitable package or structure, such as a barrel, a bag, a bucket, a cartridge or a bottle, for several months up to one year before use without their respective properties changing to an extent that is relevant for their use.

For applying a two-component composition Z1, the two components are mixed together. In this process, the mixing ratio between the two components is selected such that that the groups reactive toward isocyanate groups are present in a suitable proportion relative to the isocyanate groups. Suitably the ratio of the number of groups in the second component reactive toward isocyanate groups to the number of isocyanate groups in the first component falls in the range of 0.5 to 1.1, especially 0.6 to 1.0. In parts by weight, the mixing ratio between the first and the second component usually falls in the range of 1:10 to 10:1.

The mixing of the two components takes place by means of a suitable method; it can be done continuously or batchwise. If the mixing takes place before application, it is necessary to make sure that not too much time elapses between the mixing of the components and the application, since this could result in disturbances, such as delayed or incomplete development of adhesion to the substrate. The mixing can take place at ambient temperature, which is typically in the range of about −20 to 50° C., preferably about −10 to 30° C. However, before mixing, the components can also be heated, for example to a temperature in the range of 30 to 80° C., as a result of which especially the viscosity of the components is reduced. This is especially advantageous for application in a spray process.

With the mixing of the two components, the curing of the composition Z1 begins, in that primary and secondary amino groups, hydroxyl groups and mercapto groups present in the composition react with isocyanate groups that are present. Excess isocyanate groups react with moisture.

Thus the present invention also describes a cured composition which is obtained by the reaction of at least one polyisocyanate with at least one curing agent compound HV of an isocyanate group-containing composition Z1, as was described in the preceding.

The compositions Z1 in the form of the variants described have various advantageous and surprising properties.

If the composition Z1 is present in such a form that in addition to at least one polyisocyanate P it contains at least one polyamine of Formula (I), then it will have only a slight amine odor, be of relatively low viscosity and have a high curing speed with an pot life that is relatively long for a secondary aliphatic polyamine. In the case of aliphatic polyisocyanates P, their pot life is long enough for the components in the batch to be mixed and applied unhurriedly. As a result, the composition can be used without expensive and difficult-to-operate application equipment and in particular need not be applied using a spray method, which is advantageous for toxicologic reasons. In the case of aromatic polyisocyanates P, the pot life is naturally shorter, but in the case of application using a spray method it is still long enough to guarantee good leveling of the applied composition and good wetting of the substrate to which the composition was applied. The curing of such a composition takes place very rapidly, so that it can be worked further after only a short time. For example, in the case of a coating, further working may comprise walking on it or polishing or application of an additional layer; in the case of bonding, the loading of the bond with its own weight, as a result of which for example attachments can be removed and the bonded parts can be moved; or In the case of a cast composition, removal from the mold, making the mold available for additional use. Thus the composition cures without foam formation in the presence of high relative humidity. In the case of surface application, high-quality films of high hardness and elasticity with good adhesion to various substrates form, which especially exhibit excellent resistance to abrasion, moisture and chemicals, such as organic or inorganic acids, alkalis or solvents. In the case of aliphatic polyisocyanates P, the cured films also have excellent light stabilities without a tendency to yellowing.

If the composition Z1 is present in such a form that in addition to at least one polyisocyanate P it contains at least one adduct AD1 with a polyisocyanate, it will basically have reduced sensitivity to adverse influences during curing and even more rapid curing with approximately constant pot lifes, since part of the polyisocyanate will already have reacted with a polyamine of Formula (I) and thus the number of reactions necessary for curing the composition is reduced. An additional advantage lies in the fact that the weight- or volume-based fractions of the two components of the composition can be more easily adjusted to a desired mixing ratio between the first and the second component. Especially for mechanical applications it is often necessary to maintain a mixing ratio predetermined by the application apparatus, which is difficult under certain circumstances according to the prior art, especially if the composition is supposed to be solvent-free.

If the composition Z1 exists in such a form that in addition to at least one curing agent compound HV it contains at least one polyisocyanate in the form of an adduct AD2—thus a polyamine of Formula (I) in fully reacted form as a constituent of the isocyanate group-containing first component—similar advantages result with regard to the sensitivity during the curing, the curing speed as well as the adjustment of the mixing ratios as described above.

The compositions Z1 are suitable for a great variety of applications, especially as casting compounds, sealants, adhesives, linings, coatings, paints, lacquers, sealing agents, base coats, primers and foams for construction and industrial applications. They are especially suitable for applications which have a low solvent content or must be solvent-free, as well as for applications in which a coating or a lining is to be applied mechanically, especially in a spray process.

In addition the advantageous characteristics of the compositions Z1 described make it possible for the cured compositions to have a high content of urea groups. Such compositions Z1 are also known in the prior art as polyurea compositions. They fully cure largely without problems even at low temperatures and high humidities and in the fully cured state have high hardnesses and outstanding resistances. As a result they are especially suitable for applications that have especially high requirements for strength and durability, such as floor coverings and floor coatings for indoor rooms such as offices, industrial halls, gymnasia or cold rooms, or in the outdoor sector for balconies, terraces, parking decks, bridges or roofs, and also as protective coatings for concrete, cement, metals or plastics, for example for surface sealing of loading docks, tanks, silos, shafts, conduits or pipelines, wherein these coatings especially protect the respective substrates from corrosion, abrasion, moisture and/or chemicals, as well as surface sealants for such linings. If the compositions Z1 contain mostly or exclusively polyisocyanates P with aliphatic isocyanate groups, the fully cured compositions have excellent light stability, so that among other things, they scarcely undergo any yellowing even after prolonged exposure to light. Such compositions Z1 are especially suitable as surface sealants, cover layers or cover lacquers for paints, coatings and/or linings.

The application of the described composition Z1 takes place on at least one substrate S, wherein the following are especially suitable as substrates S:
Glass, glass-ceramics, concrete, mortar, refractory bricks, fire brick, hard plaster and natural stone such as granite or marble;
Metals and alloys, such as aluminum, iron, steel and nonferrous metals, as well as surface-coated metals and alloys, such as galvanized or chromium-plated metals;
Leather, textiles, paper, wood, wooden materials bonded with resins, for example phenol, melamine or epoxy resins, resin-textile composite materials and other so-called polymer composites;
Plastics, such as polyvinyl chloride (hard and soft PVC), acrylonitrile-butadiene-styrene-copolymers (ABS), polycarbonate (PC), polyamide (PA), polyester, poly(methylmethacrylate) (PMMA), polyesters, epoxy resins, polyurethanes (PUR), polyoxymethylene (POM), polyolefins (PO), polyethylene (PE) or polypropylene (PP), ethylene/propylene copolymers (EPM) and ethylene/propylene/diene terpolymers (EPDM), wherein the plastics can preferably be surface-treated with plasma, corona discharge or flames;
Fiber-reinforced plastics, such as carbon fiber-reinforced plastics (CFP), glass fiber-reinforced plastics (GFP) and sheet molding compound (SMC);
Coated substrates, such as powder-coated metals or alloys;
Paints and lacquers, especially automobile top coats.

If necessary, the substrates can be pretreated before applying the composition Z1. Such pretreatments especially involve physical and/or chemical cleaning methods, for example polishing, sand blasting, shot peening, brushing or the like, wherein dust produced in the process is advantageously vacuumed up, as well as additionally treating with cleaners or solvents or applying an adhesion promoter, an adhesion promoter solution or a primer.

An isocyanate group-containing composition Z1 can be used in a coating process. For this purpose, the components of the composition Z1 are mixed together using a suitable method and the mixed composition is applied to a substrate in a layer thickness from several microns up to about 5 mm. Depending on the reactivity of the composition Z1, various methods for coating are suitable. Compositions Z1 with a relatively long pot life can be mixed batchwise and the mixed composition then immediately applied to a substrate in the desired layer thickness with a roller or doctor blade. However, it can also be applied in a spray method. Compositions Z1 with a shorter pot life are suitably applied in a spray method, wherein either conventional or airless spraying methods are possible. Especially suitable are multicomponent spraying devices, in which the components of the composition Z1 are mixed immediately before spraying. To reduce the viscosity of the composition Z1 it may be advantageous to heat the components before mixing, for example to a temperature in the range of 40 to 80° C., and/or dilute it with a suitable solvent. The composition Z1 can be applied as a coating in a layer, but it can also be applied in multiple layers in multiple application steps. Therefore it may be advantageous to apply a structure of several layers each of different composition as a coating, wherein the composition can be applied either as the bottom layer, as the middle layer or as the top layer. A composition Z1 can especially be used as a protective coating for concrete, especially on bridges, wherein the composition is typically sprayed on.

An additional object of the invention is a curable composition in form of an epoxy resin composition Z2, containing

a) at least one epoxy resin and

b) at least one polyamine der Formula (I).

An epoxy resin composition Z2 is especially suitable as a coating or lining.

“Epoxide group” or “Epoxy group” is the name given to the structural element

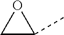

The term “glycidyl ether” is applied to an ether of 2,3-epoxy-1-propanol (glycidol).

The abbreviation “EEW” stands for “Epoxide Equivalent Weight.”

Suitable epoxy resins are epoxy resins customary in epoxy chemistry. These are obtained in known ways, for example from the oxidation of the corresponding olefins or from the reaction of epichlorohydrin with the corresponding polyols, polyphenols or amines.

Especially suitable epoxy resins are so-called polyepoxy resins, designated in the following as “liquid resin.” These have a glass transition temperature that is usually below 25° C., in contrast to the so-called solid resins, which have a glass transition temperature of above 25° C. and can be ground into powders that are free-flowing at 25° C.

In one embodiment, the liquid resin is an aromatic polyepoxide. Suitable ones for this are for example liquid resins of Formula (IX),

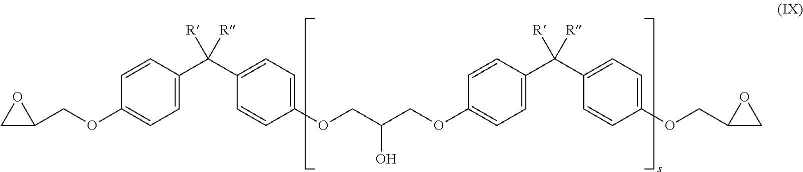

wherein R′ and R″ each independently represent a hydrogen atom or methyl group, and s on average represents a value of 0 to 1. Liquid resins of Formula (IX), in which the subscript s on average represents a value of less than 0.2.

The liquid resins of Formula (IX) are diglycidyl ethers of bisphenol A, bisphenol F and bisphenol A/F, wherein A represents acetone and F formaldehyde, which serve as reactants for producing these bisphenols. A bisphenol A liquid resin correspondingly contains methyl groups, a bisphenol F liquid resin contains hydrogen atoms and a bisphenol A/F liquid resin contains both methyl groups and hydrogen atoms as R′ and R″ in Formula (IX). In the case of bisphenol F, positional isomers may also be present, especially derived from 2,4′- and 2,2′-hydroxyphenylmethane.

Additional suitable aromatic liquid resins are the glycidylation products of
Dihydroxybenzene derivatives such as resorcinol, hydroquinone and pyrocatechol;
Additional bisphenols or polyphenols such as bis-(4-hydroxy-3-methylphenyl)-methane, 2,2-bis-(4-hydroxy-3-methylyphenyl)-propane (bisphenol C), bis-(3,5-dimethyl-4-hydroxyphenyl)-methane, 2,2-bis-(3,5-dimethyl-4-hydroxyphenyl)-propane, 2,2-bis-(3,5-dibromo-4-hydroxyphenyl)-propane, 2,2-bis-(4-hydroxy-3-tert.-butylphenyl)-propane, 2,2-bis-(4-hydroxyphenyl)-butane (bisphenol B), 3,3-bis-(4-hydroxyphenyl)-pentane, 3,4-bis-(4-hydroxyphenyl)-hexane, 4,4-bis-(4-hydroxyphenyl)-heptane, 2,4-bis-(4-hydroxyphenyl)-2-methylbutane, 2,4-bis-(3,5-dimethyl-4-hydroxyphenyl)-2-methylbutane, 1,1-bis-(4-hydroxyphenyl)-cyclohexane (bisphenol Z), 1,1-bis-(4-hydroxyphenyl)-3,3,5-trimethylcyclohexane (bisphenol TMC), 1,1-bis-(4-hydroxyphenyl)-1-phenylethane, 1,4-bis[2-(4-hydroxyphenyl)-2-propyl]-benzene) (bisphenol P), 1,3-bis-[2-(4-hydroxyphenyl)-2-propyl]-benzene) (bisphenol M), 4,4′-dihydroxydiphenyl (DOD), 4,4′-dihydroxybenzophenone, bis-(2-hydroxynaphth-1-yl)methane, bis-(4-hydroxynaphth-1-yl)-methane 1,5-dihydroxynaphthalene, tris-(4-hydroxyphenyl)methane, 1,1,2,2-tetrakis-(4-hydroxyphenyl)ethane bis-(4-hydroxyphenyl)ether, bis-(4-hydroxyphenyl)sulfone;
Condensation products of phenols with formaldehyde obtained under acidic conditions, such as phenol-novolacs or cresol-novolacs, also known as bisphenol F novolacs;
Aromatic amines, such as aniline, toluidine, 4-aminophenol, 4,4′-methylene-diphenyldiamine (MDA), 4,4′-methylene-diphenyldi-(N-methyl)-amine, 4,4′-[1,4-phenylene-bis-(1-methyl-ethylidene)]-bisaniline (bisaniline P), 4,4′-[1,3-phenylene-bis-(1-methyl-ethylidene)]-bisaniline (bisaniline M).

Also suitable as an epoxy resin is an aliphatic or cycloaliphatic polyepoxide, for example
a glycidyl ether of a saturated or unsaturated, branched or unbranched, cyclic or open-chain C₂- to C₃₀-diol, for example ethylene glycol, propylene glycol, butylene glycol, hexanediol, octanediol, a polypropylene glycol, dimethylolcyclohexane, neopentylglycol or dibromo-neopentylglycol;
a glycidyl ether of a tri- or tetrafunctional, saturated or unsaturated, branched or unbranched, cyclic or open-chain polyol such as castor oil, trimethylolpropane, trimethylolethane, pentaerythritol, sorbitol or glycerol, and alkoxylated glycerol or alkoxylated trimethylolpropane;
a hydrogenated bisphenol A, F or A/F liquid resin, or the glycidylation product of hydrogenated bisphenol A, F or A/F;
an N-glycidyl derivative of amides or heterocyclic nitrogen bases, such as triglycidyl cyanurate and triglycidyl isocyanurate, and reaction products of epichlorohydrin and hydantoin.

Also possible as epoxy resins are a bisphenol A, F or A/F solid resin, which is of similar structure to the previously mentioned liquid resins of Formula (IX), but instead of the subscript s has a value of 2 to 12, and a glass transition temperature of more than 25° C.

Finally, suitable epoxy resins may also include epoxy resins from the oxidation of olefins, for example from the oxidation of vinylcylohexene, dicyclopentadiene, cyclohexadiene, cyclododecadiene, cyclododecatriene, isoprene, 1,5-hexadiene, butadiene, polybutadiene or divinylbenzene.

Preferred epoxy resins are liquid resins on the basis of a bisphenol, especially on the basis of bisphenol A, bisphenol F or bisphenol A/F, as are commercially available for example from Dow, Huntsman and Hexion, wherein these are optionally present in combination with bisphenol A solid resin or bisphenol F-novolac epoxy resin.

The epoxy resin can contain a reactive diluent, especially an epoxide-reactive diluent. Suitable epoxide-reactive diluents are low-viscosity mono- and polyepoxides, for example the glycidyl ethers of mono- or polyvalent phenols and aliphatic or cycloaliphatic alcohols, especially the previously mentioned polyglycidyl ethers of di- or polyols, and also especially phenyl glycidyl ethers, cresyl glycidyl ethers, p-n-butyl-phenyl glycidyl ethers, p-tert.butyl-phenyl glycidyl ethers, nonylphenyl glycidyl ethers, allyl glycidyl ethers, butyl glycidyl ethers, hexyl glycidyl ethers, 2-ethylhexyl glycidyl ethers, and glycidyl ethers from natural alcohols, for example C₈- to C₁₀-alkyl glycidyl ethers or C₁₂- to C₁₄-alkyl glycidyl ethers. The addition of a reactive diluent to the epoxy resin brings about a reduction of the viscosity, and—in the fully cured state of the epoxy resin composition—a reduction of the glass transition temperature and the mechanical values.

The epoxy resin composition Z2, in addition to at least one epoxy resin and at least one polyamine of Formula (I), may contain further compounds reactive toward epoxide groups, especially additional compounds containing polyamines and especially mercapto groups.

As additional compounds reactive toward epoxide groups—in addition to the polyamines of Formula (I) described—the following are especially suitable:
Primary aliphatic polyamines, amino alcohols and aminothiols, such as the previously described amines PA of Formula (II);
Secondary aliphatic polyamines, such as those previously mentioned as possible curing agent compounds HV of an isocyanate group-containing composition Z1;
Primary and/or secondary aromatic polyamines, as were mentioned in the preceding as possible curing agent compounds HV of an isocyanate group-containing composition Z1;
amine/epoxide adducts, especially adducts of the polyamines mentioned with diepoxides in a molar ratio of at least 2/1, especially in a molar ratio of 2/1 to 6/1, and reaction products of amines and epichlorohydrin, especially those of 1,3-xylylenediamine, commercially available as Gaskamine® 328 (from Mitsubishi);
Polyamidoamines, which are reaction products of a mono- or polyvalent carboxylic acid or the esters or anhydrides thereof, especially a dimer fatty acid, and an aliphatic, cycloaliphatic or aromatic polyamines used in stoichiometric excess, especially a polyalkyleneamine, for example DETA or TETA, especially the commercially available polyamidoamines Versamid® 100, 125, 140 and 150 (from Cognis), Aradur® 223, 250 and 848 (from Huntsman), Euretek® 3607, Euretek® 530 (from Huntsman), Beckopox® EH 651, EH 654, EH 655, EH 661 and EH 663 (from Cytec);
Liquid mercaptan-terminated polysulfide polymers known under the trade names Thiokol® (from Morton Thiokol; available for example from SPI Supplies, or from Toray Fine Chemicals), especially the types LP-3, LP-33, LP-980, LP-23, LP-55, LP-56, LP-12, LP-31, LP-32 and LP-2; and also known under the trade name Thioplast® (from Akzo Nobel), especially the types G 10, G 112, G 131, G 1, G 12, G 21, G 22, G 44 and G 4;
Mercaptan-terminated polyoxyalkylene ethers, obtainable for example by reacting polyoxyalkylene di- and -triols either with epichlorohydrin or with an alkylene oxide, followed by sodium hydrogen sulfide;
Mercaptan-terminated epoxy curing agents in the form of polyoxyalkylene derivatives, known under the trade name Capcure® (from Cognis), especially the types WR-8, LOF and 3-800;
Polyesters of thiocarboxylic acids, for example pentaerythritol tetramercapto acetate, trimethylolpropane trimercaptoacetate, glycol dimercaptoacetate, pentaerythritol tetra-(3-mercaptopropionate), trimethylolpropane tri-(3-mercaptopropionate) and glycoldi-(3-mercaptopropionate), as well as the esterification products of polyoxyalkylene diols and triols, ethoxylated trimethylolpropanes and polyester-diols with thiocarboxylic acids such as thioglycolic acid and 2- or 3-mercaptopropionic acid;
Additional mercapto group-containing compounds, such as especially 2,4,6-trimercapto-1,3,5-triazine, 2,2′-(ethylenedioxy)-diethanethiol (triethylene glycol-dimercaptans) and ethanedithiol.

Additional preferred compounds reactive toward epoxide groups are DAMP, MPMD, C11-neodiamine, 1,6-hexanediamine, TMD, 1,12-dodecane diamine, 1,3-diamino-cyclohexane, H₁₂-MDA, bis-(4-amino-3-methyl-cyclohexyl)methane, IPDA, 1,3-xylylenediamine, N,N′-bis(phenylethyl)-1,3-xylylenediamin (Gaskamine® 240), polyoxyalkylene diamines and triamines, especially the types Jeffamine® D-230, Jeffamine® D-400 and Jeffamine® T-403, and amine/epoxide adducts, especially Gaskamine® 328.

The epoxy resin composition Z2 may also contain additional constituents, especially auxiliaries and additives usually used in epoxy resin compositions, for example the following:
Solvents, film forming aids or extenders, such as toluene, xylene, methyl ethyl ketone, 2-ethoxyethaneol, 2-ethoxyethyl acetate, benzyl alcohol, ethylene glycol, diethylene glycol butyl ether, dipropylene glycol butyl ether, ethylene glycol butyl ether, ethylene glycol phenyl ether, N-methylpyrrolidone, propylene glycol butyl ether, propylene glycol phenyl ether, diphenylmethane, diisopropyl naphthalene, petroleum fractions, for example Solvesso®-types (from Exxon), aromatic hydrocarbon resins, especially phenol group-containing types, sebacates, phthalates, organic phosphorus and sulfonic acid esters and sulfonamides;
Reactive diluents, for example epoxide-reactive diluents as were already mentioned in the preceding, epoxidized soy oil or linseed oil, acetoacetate group containing compounds, especially acetoacetylated polyols, butyrolactone, and also isocyanate and reactive group-containing silicones;
Polymers, for example polyamides, polysulfides, polyvinylformal (PVF), polyvinylbutyral (PVB), polyurethanes (PUR), polymers with carboxyl groups, polyamides, butadiene-acrylonitrile copolymers, styrene-acrylonitrile copolymers, butadiene-styrene copolymers, homo- or copolymers of unsaturated monomers, especially from the group comprising ethylene, propylene, butylene, isobutylene, isoprene, vinyl acetate and alkyl(meth)acrylates, especially chlorosulfonated polyethylenes and fluorine-containing polymers, sulfonamide-modified melamine and purified montan waxes;
inorganic and organic fillers, for example ground or precipitated calcium carbonates, which are optionally coated with fatty acids, especially stearates, barytes (heavy spar), talcs, quartz flour, quartz sand, dolomite, wollastonite, kaolins, mica (potassium-aluminum silicate), molecular sieves, aluminum oxides, aluminum hydroxides, magnesium hydroxide, silicas, cements, hard plasters, fly ashes, carbon black, graphite, metal powders such as aluminum, copper, iron, silver, or steel, PVC powder or hollow spheres;
Fibers, especially glass fibers, carbon fibers, metal fibers, ceramic fibers or plastic fibers such as polyamide fibers or polyethylene fibers;
Pigments, for example titanium dioxide and iron oxide;
Accelerators, which accelerate the reaction between amino groups and epoxide groups, for example acids or compounds hydrolyzable to acids, for example organic carboxylic acids such as acetic acid, benzoic acid, salicylic acid, 2-nitrobenzoic acid, lactic acid, organic sulfonic acids such as methane-sulfonic acid, p-toluolenesulfonic acid or 4-dodecylbenzene sulfonic acid, sulfonic acid esters, other organic or inorganic acids such as phosphoric acid, or mixtures of the aforementioned acids and acid esters; also tertiary amines such as 1,4-diazabicyclo[2.2.2]octane, benzyldimethylamine, □-methyl-benzyldimethylamine, triethanolamine, dimethyl-aminopropylamine, imidazoles such as especially N-methylimidazole, N-vinylimidazole or 1,2-dimethylimidazole, salts of such tertiary amines, quaternary ammonium salts, for example benzyl-trimethylammonium chloride, phenols, especially bisphenols, phenol resins and Mannich bases for example 2-(dimethyl-aminomethyl)-phenol and 2,4,6-tris-(dimethyl-aminomethyl)-phenol, phosphites, for example di- and triphenylphosphite, and mercapto group-containing compounds such as those mentioned in the preceding;
Rheology modifiers, especially thickening agents, for example phyllosilicates such as bentonite, derivatives of castor oil, hydrogenated castor oil, polyamides, polyurethanes, urea compounds, pyrogenic silicas, cellulose ethers and hydrophobically modified polyoxyethylenes;
Adhesion improvers, for example organoalkoxysilanes such as aminosilanes, mercaptosilanes, epoxysilanes, vinylsilanes, (meth)acrylic silanes, isocyanatosilanes, carbamatosilanes, alkylsilanes, S-(alkylcarbonyl)-mercaptosilanes and aldiminosilanes, as well as oligomeric forms of these silanes, especially 3-glycidoxypropyl-trimethoxysilane, 3-aminopropyl-trimethoxysilane, N-(2-amino-ethyl)-3-amino-propyl-trimethoxysilane, N-(2-aminoethyl)-N-[3-(trimethoxysilyl)propyl]-ethylenediamine, 3-mercaptopropyl trimethoxysilane, 3-isocyanatopropyl trimethoxysilane, 3-ureidopropyl trimethoxysilane, 3-chloropropyl trimethoxysilane, vinyl-trimethoxysilane, or die corresponding organosilanes with ethoxy groups instead of the methoxy groups;
Stabilizers against oxidation, heat, light and UV radiation;
Flame-retardant substances, especially compounds such as aluminum hydroxide (Al(OH)₃; also known as ATH for “aluminum trihydrate”), magnesium hydroxide (Mg(OH)₂; also known as MDH for “magnesium dihydrate”), ammonium sulfate ((NH₄)₂SO₄), boric acid (B(OH)₃), zinc borate, melamine borate and melamine cyanurate; phosphorus-containing compounds such as ammonium phosphate ((NH₄)₃PO₄), ammonium polyphosphate, melamine phosphate, melamine pyrophosphate, triphenyl phosphate, diphenyl cresyl phosphate, tricresyl phosphate, triethyl phosphate, tris-(2-ethylhexyl)phosphate, trioctyl phosphate, mono-, bis- and tris-(isopropylphenyl)phosphate, resorcinol-bis(diphenyl phosphate), resorcinol diphosphate oligomers, tetraphenyl resorcinol diphosphite, ethylenediamine diphosphate and bisphenol A-bis(diphenyl phosphate); halogen-containing compounds such as chloroalkyl phosphates, especially tris-(chloroethyl)phosphate, tris-(chloropropyl)phosphate and tris-(dichloroisopropyl)phosphate, polybrominated diphenyl ethers, especially decabromo diphenyl ether, polybrominated diphenyl oxide, tris-[3-bromo-2,2-bis(bromomethyl)propyl]phosphate, tetrabromo-bisphenol A, bis-(2,3-dibromopropyl ether) of bisphenol A, brominated epoxy resins, ethylene-bis(tetrabromophthalimide), ethylene-bis(dibromonorbornane dicarboximide), 1,2-bis-(tribromophenoxy)ethane, tris-(2,3-dibromopropyl)isocyanurate, tribromophenol, hexabromocyclododecane, bis-(hexachlorocyclopentadieno)cyclooctane and chloroparaffins; as well as combinations of a halogenated compound and antimony trioxide (Sb₂O₃) or antimony pentoxide (Sb₂O₅);
Surface-active substances, for example wetting agents, leveling agents, deaerating agents or defoamers;
Biocides, for example algicides, fungicides or mold growth-inhibiting substances.

Preferably the epoxy resin composition Z2 contains additional auxiliaries and additives, especially wetting agents, leveling agents, defoamers, stabilizers, pigments and accelerators especially salicylic acid or 2,4,6-Tris-(dimethylaminomethyl)-phenol.

Preferably the epoxy resin composition Z2 contains only a small fraction of solvents, particularly preferably less than 10 wt.-%, especially less than 5 wt.-% solvents. Most preferably the composition is essentially free from solvents, wherein the term “solvents” in the present document also includes substances such as benzyl alcohol and alkylphenols.

Advantageously the epoxy resin composition Z2 is in the form of a two-component composition.

A two-component epoxy resin composition Z2 consists of a so-called resin component, which contains at least one epoxy resin, and a so-called curing agent component, which contains at least one polyamine of Formula (I) and optionally additional compounds reactive toward epoxide groups.

Additional constituents of a two-component epoxy resin composition Z2 can be present as constituents of the resin or the curing agent component.

The resin component and the curing agent component of a two-component epoxy resin composition Z2 can each be stored in a suitable package or arrangement, for example a barrel, a hobbock, a bag, a bucket, a can, a cartridge or a tube, for several months up to one year or longer before use without undergoing a change in their respective properties to an extent relevant for their use.

To use a two-component epoxy resin composition Z2 the resin component and the curing agent component are mixed together shortly before or during the application. The mixing ratio between the two components is preferably selected such that the groups of the curing agent component reactive toward epoxide groups are present in a suitable ratio to the epoxide groups of the resin component.

The ratio of the number of groups in the curing agent component reactive toward epoxide groups to the number of epoxide groups of the resin component is preferably in the range of 0.5 to 1.5, especially 0.8 to 1.2.

It is known to the person skilled in the art that primary amino groups are difunctional toward epoxide groups, and thus one primary amino group counts as two groups reactive toward epoxide groups.

In parts by weight. The mixing ratio between the resin component and the curing agent component is usually in the range of 1:10 to 10:1.

The mixing of the two components is performed by a suitable method; it may be done continuously or batchwise. If the mixing takes place before application, it is necessary to make sure that too much time does not elapse between the mixing of the components and the application, since this could cause problems, for example slow or incomplete development of the adhesion to the substrate. The mixing especially takes place at ambient temperature, which for the application of an epoxy resin composition typically falls in the range of about 0 to 50° C., preferably about 10 to 30° C.

With the mixing of the two components, the curing of the epoxy resin composition Z2 described by chemical reaction begins. Here, the NH hydrogens of the polyamines of Formula (I) present in the mixed composition and optionally other groups reactive toward epoxy groups present react with epoxy groups, which undergo ring opening (addition reactions). As a result of these reactions, the composition undergoes polymerization and finally complete curing. The complete curing especially takes place at ambient temperature, which is typically in the range of about 0 to 50° C., preferably about 10 to 30° C. Curing typically takes several days to weeks before it is largely complete under the indicated conditions. The duration depends, among other things, on the temperature, the reactivity of the constituents and their stoichiometry as well as the presence of accelerators.

Thus the present invention also describes a fully cured composition obtained by the reaction of at least one epoxy resin with at least one polyamine of Formula (I) of an of an epoxy resin composition Z2, as described in the preceding.

The application of the epoxy resin compositions Z2 described is performed on at least one substrate, wherein the previously mentioned substrates S are suitable as substrates. If needed, the substrates S can be treated before applying the epoxy resin composition, as was previously described.

The polyamines of Formula (I) contained in the epoxy resin compositions Z2 are, as was previously mentioned, typically low-viscosity substances of low volatility and little odor, which are surprisingly quite compatible with the usual commercial epoxy resins. Without intending to limit the invention, it is proposed that the good tolerability is at least partially attributable to the effect of the groups introduced by the aldehydes ALD of Formula (III), located at the ends of the molecules, during the reductive alkylation.

An epoxy resin composition Z2 can be used in a coating process. For this purpose, the epoxy resin composition Z2 advantageously has a liquid consistency with good flow properties. In this way it can especially be applied as a self-leveling coating on predominantly flat surface, for example as a floor covering. This means that the composition has a low viscosity during application. Preferably the epoxy resin composition Z2 has a viscosity during application—thus immediately after the mixing of the resin and the curing agent component—measured with a ball-and-plate viscometer at 20° C., in the range of 100 to 3.000 mPa·s, especially in the range of 100 to 2.000 mPa·s, most preferably in the range of 100 b is 1,500 mPa·s. Such relatively low viscosities for epoxy resin compositions usually can only be attained using low-viscosity curing agents, if the use of solvents and diluents is to be avoided. Therefore one essential aspect of the invention is that the polyamines of Formula (I) are typically liquid and low-viscosity compounds.

Before application, the resin and the curing agent component are mixed together in an appropriate way and the mixed composition is applied to a substrate in a laminar manner within its pot life as a thin film with a layer thickness of typically about 50 □m, typically at ambient temperature. The application is performed, for example, by casting onto the substrate to be coated. In this process the mixed composition is distributed uniformly using, for example, a doctor blade or a notched trowel. In addition the mixed, distributed composition can be smoothed and the air removed using a spiked roller. However, application by machine is also possible, for example in the form of a spray application.

It is also possible to apply a mixed two-component epoxy resin composition Z2 to a substrate using a brush, cloth, sponge, or a spray gun, especially if the composition is to be applied in a thin layer less than 1 mm thick, for example as a primer or as a surface sealant. For such an application, the composition Z2 usually contains solvents.

During the curing, typically largely clear, lustrous and non-tacky films are formed, which have excellent mechanical properties, such as high hardness good scratch resistance and durability, and good adhesion to a great variety of substrates. In contrast, epoxy resin compositions according to the prior art which contain curing agents with mainly primary amino groups instead of polyamines of Formula (I) often cure into films with blushing-related surface defects such as roughness, spotting, clouding and tackiness.

Thus the use of the polyamines of Formula (I) as curing agents makes available self-leveling epoxy resin coatings which require relatively little or no addition of diluents such as solvents. In addition, the content of primary amino groups in the coatings can be kept so low that scarcely any reactions with CO₂ from air take place. As a result, blushing effects largely do not appear even under unfavorable reaction conditions, specifically low curing temperatures, for example in the range of 0 to 10° C., and high humidity. It is therefore possible to mostly or completely dispense with the addition of the additives used to prevent blushing according to the prior art, which are not bound covalently in the composition during final hardening and outgas as VOC, for example especially benzyl alcohol. The epoxy resin compositions Z2 described thus can also be used especially advantageously in indoor spaces.

The epoxy resin compositions Z2 described can be used as casting compositions, sealants, adhesives, primers or foams, especially for laminar applications, especially as linings, coatings, paints, lacquers, sealants and base coats, for construction and industrial applications, for example as floor coatings and floor linings for indoor rooms such as offices, industrial halls, gymnasia or cold rooms, or in the outdoor sector, for balconies, terraces, parking decks, bridges, or roofs and as a protective coating for concrete or metals, especially as a protective paint to prevent corrosion, and also as a surface sealant for such coverings.

In these applications, their excellent properties such as water-tightness, corrosion protection, adhesion, chemical resistance and/or hardness and durability, especially their excellent properties in terms of laminar curing into largely clear, lustrous and non-tacky films without blushing-related surface defects are greatly appreciated.

### EXAMPLES

### 1. Description of the Measurement Methods

The amine content, i.e., the total content of free amino groups and blocked amino groups (imino groups) in the compounds produced, was determined titrimetrically (with 0.1N HClO₄ in glacial acetic acid, against crystal violet) and is always reported in mmol N/g.

Infrared spectra were measured on undiluted films (if necessary by dissolving the substance in CH₂Cl₂ and concentrating the applied solvent to dryness under vacuum) on a Perkin-Elmer 1600 FT-IR apparatus equipped with a horizontal ATR-measuring unit with a ZnSe-crystal; the absorption bands are given in wave numbers (cm⁻¹) (measurement window: 4000-650 cm⁻¹); the suffix sh refers to a band appearing as a shoulder.

¹H-NMR spectra were measured on a Bruker Model DPX-300 spectrometer at 300.13 MHz; the chemical shifts δ are given in ppm relative to tetramethylsilane (TMS), coupling constants J are reported in Hz. No distinction was made between true and pseudo coupling patterns.

The viscosities were measured on a Rheotec RC30 cone/plate viscometer (cone diameter 50 mm, cone angle 1°, cone tip-plate distance 0.05 mm, shear rate 10-100 s⁻¹).

### 2. Production of Aldehydes of Formula (III)

### 2,2-Dimethyl-3-bis(2-methoxyethyl)amino-propanal

31.3 g (0.37 mol) 36% aqueous formaldehyde and 28.4 g (0.39 mol) isobutyraldehyde were placed in a round-bottom flask under a nitrogen atmosphere. While agitating and cooling with ice, 50.0 g (0.37 mol) bis(2-methoxyethyl)amine were slowly dropped in using a dropping funnel, making sure that the temperature of the reaction mixture did not rise above 20° C. After addition was complete, the mixture was agitated for one hour at room temperature. The resulting reaction mixture was agitated under reflux in an oil bath at 100° C. for 18 hours, then cooled to room temperature and the phases separated in a separatory funnel. The organic phase was fractionated under vacuum without additional workup. The product distilled over at a head temperature of 66° C. and a pressure of 0.04 mbar.

### 2,2-Dimethyl-3-(N-morpholino)-propanal

In the same way as described for 2,2-dimethyl-3-bis(2-methoxyethyl)-amino-propanal, 83.1 g (1.00 mol) 36% aqueous formaldehyde, 75.0 g (1.04 mol) isobutyraldehyde and 87.1 g (1.00 mol) morpholine were mixed together. During purification, the product distilled over at a head temperature of 97° C. and a pressure of 14 mbar.

### 2,2-Dimethyl-3-dimethylamino-propanal

In the same way as described for 2,2-dimethyl-3-bis(2-methoxyethyl)-amino-propanal, 83.1 g (1.00 mol) 36% aqueous formaldehyde, 79.3 g (1.10 mol) isobutyraldehyde and 112.7 g (1.00 mol) 40% aqueous dimethylamine were reacted. During purification, the product distilled over at a head temperature of 94 C and a pressure of 16 mbar.

### 2,2-Dimethyl-3-(N-pyrrolidino)-propanal

In the same way as described for 2,2-dimethyl-3-bis(2-methoxyethyl)-amino-propanal, 59.8 g (0.72 mol) 36% aqueous formaldehyde, 53.8 g (0.75 mol) isobutyraldehyde and 51.0 g (0.72 mol) pyrrolidine were reacted. During purification, the product distilled over at a head temperature of 80° C. and a pressure of 17 mbar.

### 2,2-Dimethyl-3-methylamino-propanal

In a round-bottom flask under a nitrogen atmosphere, 14.0 g (0.47 mol) paraformaldehyde, 36.0 g (0.50 mol) isobutyraldehyde and 24.0 g (0.36 mol) methylamine hydrochloride were placed together. The reaction mixture was agitated under reflux in an oil bath at 100° C. for 4 hours, whereupon a homogenous yellowish liquid was produced, which solidified upon cooling to room temperature. The product was taken up in 150 ml water, washed with diethyl ether and the aqueous phase neutralized with KOH. In this process a yellowish-brown oil separated out; this was taken up in diethyl ether. The ether solution was completely concentrated under vacuum, and the residue fractionated under vacuum. The product distilled over at a head temperature of 48° C. and a pressure of 16 mbar.

### N,N′-bis(2,2-dimethyl-3-oxopropyl)-piperazine

In a round-bottom flask under a nitrogen atmosphere were placed 166.8 g (2.00 mol) 36% aqueous formaldehyde and 150.4 g (2.08 mol) isobutyraldehyde. While agitating vigorously and cooling with ice, 86.1 g (1.00 mol) piperazine were dropped in, making sure that the temperature of the reaction mixture did not exceed 20° C. After addition was complete, the mixture was agitated for 1 hour at room temperature. The thick suspension was agitated in an oil bath at 120° C. for 18 hours under reflux. The clear, dark orange reaction mixture was cooled to room temperature, whereupon it crystallized into a solid composition. The solid composition was broken up with a pestle, suspended in water and filtered by suction. The crude product was recrystallized from ethyl acetate, whereupon pale yellow, odorless acicular crystals were obtained.

### 3. Production of Polyamines of Formula (I)

### Substances Used

| | |
|---|---|
| Jeffamine ® D-230 | Polypropylene glycol diamine, |
| (Huntsman) | mean molecular weight approx. 240 g/mol, |
| | amine content approx. 8.29 mmol N/g |
| N4-amine (BASF) | N,N′-bis(3-aminopropyl)-ethylenediamine |
| TETA (Delamine) | Triethylenetetramine (technical), |
| | amine content approx. 25.67 mmol N/g |
| TEPA (Delamine) | Tetraethylene pentamine (technical), |
| | amine content approx. 24.06 mmol N/g |

### General Manufacturing Procedure for Reductive Alkylation

In a round-bottom flask, an aldehyde and an amine were dissolved in a sufficient quantity of isopropanol under a nitrogen atmosphere. The solution was agitated for 30 minutes at room temperature and then hydrogenated at a hydrogen pressure of 80 bar, a temperature of 80° C. and a flow rate of 3 ml/min in a continuously operating hydrogenation apparatus with a Pd/C packed-bed catalyst. To monitor the progress of the reaction, IR spectroscopy was used to determine whether the imine band at approx. 1665 cm⁻¹ had disappeared. Then the solution was concentrated under vacuum at 80°.

### Example 1

In accordance with the general manufacturing specification for reductive alkylation, 21.73 g 2,2-dimethyl-3-bis(2-methoxyethyl)amino-propanal and 12.00 g Jeffamine® D-230 were reacted. Yield: 29.31 g of a clear, colorless oil with a viscosity of 220 mPa·s at 20° C. and an amine content of 5.94 mmol N/g.

FT-IR: 3336 (N—H), 2962, 2925, 2868, 2812, 1724, 1457, 1372, 1301, 1274, 1195, 1115, 1015, 960, 927, 837, 787.

### Example 2

In accordance with the general manufacturing specification for reductive alkylation, 34.25 g 2,2-dimethyl-3-(N-morpholino)-propanal and 24.00 g Jeffamine® D-230 were reacted. Yield: 52.08 g of a clear, light yellow oil with a viscosity of 430 mPa·s at 20° C. and an amine content of 6.79 mmol N/g.

FT-IR: 3334 (N—H), 2954, 2880, 2849, 2799, 1474, 1454, 1373, 1359, 1317, 1283, 1262, 1203, 1116, 1070, 1037, 1012, 932, 863, 804, 760.

### Example 3

In accordance with the general manufacturing specification for reductive alkylation, 20.54 g 2,2-dimethyl-3-(N-morpholino)-propanal and 10.45 g N4-amine were reacted. Yield: 27.5 g of a clear, colorless oil with a viscosity of 980 mPa·s at 20° C. and an amine content of 11.92 mmol N/g.

FT-IR: 3296 (N—H), 2947, 2914 sh, 2887, 2847, 2798, 2681 sh, 1977, 1454, 1394, 1373, 1351, 1317, 1282, 1263, 1202, 1135 sh, 1115, 1070, 1037, 1011, 932, 881 sh, 862, 804, 743.

¹H-NMR (CDCl₃, 300 K): δ 3.66 (t, J=4.6, 8 H, OCH₂CH₂N), 2.71 (s, 4H, NHCH₂CH₂NH), 2.66 and 2.62 (2×t, J=6.0, 2×4 H, NHCH₂CH₂CH₂NH), 2.50 (t, J=4.6, 8 H, OCH₂CH₂N), 2.40 (s, 4H, NCH₂C(CH₃)₂), 2.16 (s, 4H, NHCH₂C(CH₃)₂), 1.66 (quint, J=6.9, 4 H, NHCH₂CH₂CH₂NH), 1.25 (br s, 4H, NH), 0.87 (s, 12H, C(CH₃)₂).

### Example 4

In accordance with the general manufacturing specification for reductive alkylation, 34.24 g 2,2-dimethyl-3-(N-morpholino)-propanal and 18.41 g TETA were reacted. Yield: 41.5 g of a clear, light yellow oil with a viscosity of 900 mPa·s at 20° C. and an amine content of 12.82 mmol N/g.

FT-IR: 3311 (N—H), 2947, 2911 sh, 2886, 2846, 2796, 2685 sh, 1454, 1393, 1372, 1357, 1317, 1282, 1264, 1202, 1133 sh, 1115, 1070, 1037, 1011, 932, 877 sh, 862, 804, 760.

### Example 5

In accordance with the general manufacturing specification for reductive alkylation, 26.59 g 2,2-dimethyl-3-(N-morpholino)-propanal and 14.0 g TEPA were reacted. Yield: 34.95 g of a clear, colorless oil with a viscosity of 2800 mPa·s at 20° C. and an amine content of 11.21 mmol N/g.

FT-IR: 3308 (N—H), 2886, 2855, 2802, 2674, 1456, 1395, 1374, 1357, 1317, 1282, 1264, 1203, 1114, 1070, 1037, 1011, 932, 863, 804, 770.

### Example 6

In accordance with the general manufacturing specification for reductive alkylation, 35.96 g 2,2-dimethyl-3-(N-morpholino)-propanal and 17.03 g 1-amino-3-aminomethyl-3,5,5-trimethylcyclohexane (=isophorone diamine) were reacted. Yield: 43.4 g of a clear, colorless oil with a viscosity of 8800 mPa·s at 20° C. and an amine content of 8.04 mmol N/g.

FT-IR: 3313 (N—H), 2949, 2890, 2847, 2799, 1652, 1456, 1375, 1360, 1317, 1282, 1263, 1202, 1116, 1070, 1037, 1011, 932, 863, 805, 745, 668.

### Example 7

In accordance with the general manufacturing specification for reductive alkylation, 26.4 g 2,2-dimethyl-3-(N-morpholino)-propanal and 10.0 g 1,3-bis(aminomethyl)-benzene (=meta-xylylenediamine) were reacted. Yield: 31.5 g of a clear, colorless oil with a viscosity of 950 mPa·s at 20° C. and an amine content of 8.93 mmol N/g.

FT-IR: 3314 (N—H), 2951, 2888, 2848, 2799, 2685, 1977, 1935, 1607, 1590, 1454, 1394, 1374, 1357, 1316, 1282, 1263, 1202, 1116, 1070, 1037, 931, 862, 804, 780, 752, 700.

### Example 8

In accordance with the general manufacturing specification for reductive alkylation, 53.94 g 2,2-dimethyl-3-(N-morpholino)-propanal and 21.34 g 1,3-his (aminomethyl)cyclohexane were reacted. Yield: 65.2 g of a clear, colorless oil with a viscosity of 1900 mPa·s at 20° C. and an amine content of 9.08 mmol N/g.

FT-IR: 3315 (N—H), 2951, 2887, 2848, 2799, 1977, 1940, 1607, 1589, 1454, 1395, 1358, 1316, 1282, 1263, 1202, 1114, 1070, 1037, 931, 862, 804, 781, 702, 668.

### Example 9

In accordance with the general manufacturing specification for reductive alkylation, 35.96 g 2,2-dimethyl-3-(N-morpholino)-propanal and 21.04 g bis-(p-aminocyclohexyl)methane were reacted. Yield: 49.5 g of a clear, colorless oil with a viscosity of 3000 mPa·s at 20° C. and an amine content of 8.83 mmol N/g.

FT-IR: 3305 (N—H), 2915, 2847, 2798, 1558, 1454, 1374, 1358, 1318, 1283, 1262, 1202, 1115, 1070, 1011, 932, 863, 804, 720, 668.

### Example 10

In accordance with the general manufacturing specification for reductive alkylation, 35.96 g 2,2-dimethyl-3-(N-morpholino)-propanal and 16.60 g of a solution of 70 wt.-% hexamethylenediamine in water were reacted. Yield: 40.50 g of a clear, colorless oil with a viscosity of 400 mPa·s at 20° C. and an amine content of 9.14 mmol N/g.

FT-IR: 3340 (N—H), 2967, 2929, 2809, 1652, 1465, 1404, 1377, 1340, 1306, 1160, 1112, 1070, 1037, 1010, 951, 862, 816.

### Example 11

In accordance with the general manufacturing specification for reductive alkylation, 35.96 g 2,2-dimethyl-3-(N-morpholino)-propanal and 12.82 g of a mixture of approx. 80 wt.-% 1,3-diamino-4-methyl-cyclohexane and approx. 20 wt.-% 1,3-diamino-2-methyl-cyclohexane were reacted. Yield: 42.20 g of a clear, slightly yellowish oil with a viscosity of 3′700 mPa·s at 20° C. and an amine content of 8.91 mmol N/g.

FT-IR: 3320 (N—H), 2949, 2848, 2799, 1734, 1668, 1455, 1374, 1358, 1318, 1282, 1261, 1203, 1140, 1115, 1070, 1036, 1011, 932, 863, 804, 729.

### Example 12

In accordance with the general manufacturing specification for reductive alkylation, 35.9 g 2,2-dimethyl-3-(N-morpholino)-propanal and 6.0 g ethylenediamine were reacted. Yield: 37.79 g of a whitish crystalline substance with an amine content of 10.5 mmol N/g.

FT-IR: 3318 (N—H), 2950, 2887, 2850, 2799, 2688, 1978, 1935, 1726, 1679, 1612, 1590, 1454, 1395, 1374, 1358, 1316, 1282, 1264, 1203, 1116, 1070, 1037, 1011, 932, 910, 863, 804, 780, 753.

### Example 13

In accordance with the general manufacturing specification for reductive alkylation, 25.84 g 2,2-dimethyl-3-dimethylamino-propanal and 24.00 g Jeffamine® D-230 were reacted. Yield: 45.50 g of a clear, colorless oil with a viscosity of 1701 mPa·s at 20° C. and an amine content of 8.5 mmol N/g.

FT-IR: 3327 (N—H), 2942, 2864, 2815, 2763, 1885, 1638, 1453, 1372, 1263, 1154, 1110, 1095, 1042, 908, 844, 788, 758.

### Example 14

In accordance with the general manufacturing specification for reductive alkylation, 19.5 g 2,2-dimethyl-3-dimethylamino-propanal and 13.05 g N4-amine were reacted. Yield: 25.2 g of a clear, colorless oil with a viscosity of 78 mPa·s at 20° C. and an amine content of 14.90 mmol N/g.

FT-IR: 3297 (N—H), 2939, 2840, 2813, 2763, 1453, 1374, 1359, 1317, 1263, 1120, 1042, 956, 899, 844, 741.

¹H-NMR (CDCl₃, 300 K): δ 2.71 (s, 4H, NHCH₂CH₂NH), 2.66 and 2.64 (2×t, J=6.8, 2×4H, NHCH₂CH₂CH₂NH), 2.41 (s, 4H, NCH₂C(CH₃)₂), 2.27 (s, 12H, N(CH₃)₂), 2.14 (s, 4H, NHCH₂C(CH₃)₂), 1.67 (quint, J=6.9, 4 H, NHCH₂CH₂CH₂NH), 1.3 (br s, 4H, NH), 0.88 (s, 12H, C(CH₃)₂).

### Example 15

In accordance with the general manufacturing specification for reductive alkylation, 13.87 g 2,2-dimethyl-3-dimethylamino-propanal and 9.88 g TETA were reacted. Yield: 20.30 g of a clear, light yellow oil with a viscosity of 54 mPa·s at 20° C. and an amine content of 15.5 mmol N/g.

FT-IR: 3299 (N—H), 2939, 2841, 2812, 2763, 1738, 1667, 1454, 1378, 1360, 1334, 1263, 1122, 1042, 938, 896, 844, 754.

### Example 16

In accordance with the general manufacturing specification for reductive alkylation, 67.83 g 2,2-dimethyl-3-dimethylamino-propanal and 35.56 g 1,3-bis(aminomethyl)cyclohexane were reacted. Yield: 87.8 g of a clear, colorless oil with a viscosity of 160 mPa·s at 20° C. and an amine content of 10.24 mmol N/g.

FT-IR: 3345 (N—H), 3217, 3034, 2911, 2841, 1912, 1833, 1728, 1603, 1491, 1459, 1374, 1312, 1161, 1126, 1043, 995, 952, 866, 777, 691.

### Example 17

In accordance with the general manufacturing specification for reductive alkylation, 31.05 g 2,2-dimethyl-3-(N-pyrrolidino)-propanal and 24.00 g Jeffamine® D-230 were reacted. Yield: 50.86 g of a clear, colorless oil with a viscosity of 200 mPa·s at 20° C. and an amine content of 7.7 mmol N/g.

FT-IR: 3336 (N—H), 2962, 2870, 2780, 1652, 1472, 1372, 1340, 1306, 1285, 1240, 1108, 1030, 906, 874, 788.

### Example 18

In accordance with the general manufacturing specification for reductive alkylation, 11.5 g freshly distilled 2,2-dimethyl-3-methylamino-propanal and 12.00 g Jeffamine® D-230 were reacted. Yield: 20.2 g of a clear, colorless oil with a viscosity of 200 mPa·s at 20° C.

FT-IR: 3316 (N—H), 2961, 2867, 1679, 1467, 1451, 1372, 1345, 1300, 1277, 1242, 1149 sh, 1110, 1034, 1011, 908, 844, 815, 742, 681.

### Example 19

In accordance with the general manufacturing specification for reductive alkylation, 34.98 g N,N′-bis(2,2-dimethyl-3-oxopropyl)-piperazine and 42.58 g isophorone diamine were reacted. Yield: 69.00 g of a nearly clear, yellowish oil with a viscosity of 29′100 mPa·s at 20° C. and an amine content of 10.7 mmol N/g.

FT-IR: 3307 (N—H), 2946, 2893, 2833, 2800, 1580, 1558, 1459, 1376, 1362, 1318, 1278, 1150, 1118, 1067, 1016, 892, 831, 769.

### Comparison Example 44

In accordance with the general manufacturing specification for reductive alkylation, 7.21 g isobutyraldehyde and 9.46 g TEPA were reacted. The product was a clear, yellowish oil with a viscosity of 270 mPa·s at 20° C. and an amine content of 14.6 mmol N/g.

### Comparison Example 45

In accordance with the general manufacturing specification for reductive alkylation, 12.82 g 2-ethyl-capronaldehyde and 9.46 g TEPA were reacted. The product was a clear, yellowish oil with a viscosity of 100 mPa·s at 20° C. and an amine content of 11.1 mmol N/g.

### Comparison Example 46

In accordance with the general manufacturing specification for reductive allylation, 7.21 g isobutyraldehyde and 8.71 g N4-amine were reacted. The product was a clear, yellowish oil with a viscosity of 320 mPa·s at 20° C. and an amine content of 13.7 mmol N/g.

### Comparison Example 47

In accordance with the general manufacturing specification for reductive alkylation, 12.82 g 2-ethyl-capronaldehyde and 8.71 g N4-amine were reacted. The product was a clear, yellowish oil with a viscosity of 70 mPa·s at 20° C. and an amine content of 9.2 mmol N/g.

### 4. Production of Epoxy Resin Compositions

### Substances Used

| | |
|---|---|
| Araldite ® GY 250 | Bisphenol A-diglycidyl ether, EEW approx. |
| (Huntsman) | 187.5 g/Eq |
| Araldite ® DY-E | Monoglycidyl ether of a C₁₂- to C₁₄-alcohols, |
| (Huntsman) | EEW approx. 290 g/Eq |
| Ancamine ® K 54 | 2,4,6-Tris-(dimethylaminomethyl)-phenol |
| (Air Products) | |

### Examples 20 to 25 and Comparison Examples 48 to 51

For each example, the ingredients listed in Table 1 in the indicated quantities (in parts by weight) were mixed using a centrifugal mixer (SpeedMixer™ DAC 150, FlackTek Inc.). When data are reported, the viscosity of the mixed composition was determined 10 minutes after mixing at 20° C. In addition, in each case a film with a layer thickness of 500 μm was drawn on a glass plate and this was held at 23° C. and 50% relative humidity (=standard climate, abbreviated as “SC” in the following), or fully cured. The appearance of the films was evaluated after 4 weeks. A film was designated as “defect-free” if it was clear and had a hard, lustrous, non-tacky surface without texture. “Texture” is the term applied to any form of marking or pattern appearing on the surface. “Matte” was the term applied to a film that was clear had a hard, non-tacky surface without texture, but also without luster. In addition, the König hardness (pendulum hardness according to König, measured according to DIN EN ISO 1522) of the films after 7 days (“König hardness (7d)”) and after 14 days (“König hardness (14d)”) or 4 weeks (“König hardness (4w)”) was determined.

The results are shown in Tables 1 and 1a.

TABLE 1
Composition and properties of Examples 20 to 25.

| | | Example | | | | | |
|---|---|---|---|---|---|---|---|
| | | 20 | 21 | 22 | 23 | 24 | 25 |
| Araldite ® | | 167.2 | 167.2 | 167.2 | 167.2 | 167.2 | 167.2 |
| GY-250 | | | | | | | |
| Araldite ® | | 31.8 | 31.8 | 31.8 | 31.8 | 31.8 | 31.8 |
| DY-E | | | | | | | |
| Isophorone | | — | — | 18.9 | — | 21.3 | — |
| diamine | | | | | | | |
| Jeffamine ® | | — | — | — | — | — | 24.0 |
| D-230 | | | | | | | |
| Polyamine | | 121.0 | — | — | — | — | — |
| Ex. 3 | | | | | | | |
| Polyamine | | — | 99.8 | 55.4 | — | — | — |
| Ex. 5 | | | | | | | |
| Polyamine | | — | — | — | 100.2 | — | — |
| Ex. 14 | | | | | | | |
| Polyamine | | — | — | — | — | 54.8 | — |
| Ex. 18 | | | | | | | |
| Polyamine | | — | — | — | — | — | 56.3 |
| Ex. 19 | | | | | | | |
| Ancamine ® | | — | 6.0 | 5.6 | 6.0 | 5.6 | 5.6 |
| K 54 | | | | | | | |
| Viscosity (10′) | | n.d. | n.d. | n.d. | 0.56 | 0.50 | 1.24 |
| [Pa · s] | | | | | | | |
| König | (7 d) | 35 | 108 | 126 | 85 | 87 | 188 |
| hard- | (14 d) | 92 | 140 | 182 | 86 | 139 | 197 |
| ness | (4 w) | 154 | 160 | 197 | 86 | 148 | 205 |
| [s] | | | | | | | |

| | | | | | | |
|---|---|---|---|---|---|---|
| Appearance | Defect- | Defect- | Slight | Defect- | Matte | Defect- |
| | free | free | texture | free | | free |

“Ex.” means “example,
” n.d. “means” not determined

It is apparent from Table 1 that the epoxy resin compositions of Examples 20 to 25 cured to form high-quality, clear films.

TABLE 1a
Composition and properties of comparison examples 48 to 51.

| | Example | | | |
|---|---|---|---|---|
| | 48 | 49 | 50 | 51 |
| | (Compar.) | (Compar.) | (Compar.) | (Compar.) |
| Araldite ® GY-250 | 167.2 | 167.2 | 167.2 | 167.2 |
| Araldite ® DY-E | 31.8 | 31.8 | 31.8 | 31.8 |
| Polyamine Compar. | 60.3 | — | — | — |
| Ex. 44 | | | | |
| Polyamine Compar. | — | 82.7 | — | — |
| Ex. 45 | | | | |
| Polyamine Compar. | — | — | 71.6 | — |
| Ex. 46 | | | | |
| Polyamine Compar. | — | — | — | 99.7 |
| Ex. 47 | | | | |
| Ancamine ® K 54 | 5.2 | 5.6 | 5.4 | 6.0 |
| Viscosity (10′) [Pa · s] | 0.6 | 0.8 | 0.4 | 0.5 |
| König hardness [s](2 d) | n.m. | 24 | n.m. | n.m. |
| (4 d) | n.m. | 29 | n.m. | n.m. |
| (7 d) | n.m. | 41 | n.m. | n.m. |
| (4 w) | n.m. | 70 | n.m. | n.m. |
| Appearance | Very | Tacky | Very | Very |
| | tacky | | tacky | tacky |

“Compar.” means “Comparison”; “Compar. Ex.” means “Comparison example”; “n.m.” means “not measurable” (too tacky)

### 6. Production of Isocyanate a Group-Containing Compositions

### Substances Used

| | |
|---|---|
| Jeffamine ® D-2000 (Huntsman) | Polypropylene glycol diamine, |
| (_{“}D-2000”) | mean molecular weight approx. 2000 g/mol, |
| | amine content approx. 0.98 mmol N/g |
| Jeffamine ® SD-2001 (Huntsman) | N,N′-Diisopropyl-polypropylene glycol diamine, |
| (_{“}SD-2001”) | mean molecular weight approx. 2000 g/mol, amine |
| | content approx. 0.95 mmol N/g |
| Jeffamine ® T-5000 (Huntsman) | Polypropylene glycol triamine, |
| (_{“}T-5000”) | mean molecular weight approx. 5000 g/mol, |
| | amine content approx. 0.53 mmol N/g |
| Desmophen ® NH 1220 (Bayer) | Adduct from 1,5-diamino-2-methylpentane and |
| (_{“}NH 1220”) | diethyl maleate in 1/2 molar ratio, amine content |
| | approx. 4.35 mmol N/g |
| Desmophen ® NH 1420 (Bayer) | Adduct from bis-(4-aminocyclohexyl)-methane |
| (_{“}NH 1420”) | and diethyl maleate in molar ratio, amine content |
| | approx. 3.60 mmol N/g |
| Jefflink ® 754 (Huntsman) | N,N′-Diisopropyl-1-amino-3-aminomethyl-3,5,5- |
| (_{“}Jefflink”) | trimethylcyclohexane |
| Ethacure ® 100 (Albermale) | Mixture of approx. 80 wt.-% 2,4-diamino-3,5- |
| (_{“}DETDA”) | diethyltoluolene and approx. 20 wt.-% 2,6- |
| | diamino-3,5-diethyltoluene |
| Ruetasolv ® DI (Rütgers) | Diisopropylnaphthalene |
| (“Ruetasolv”) | |

### Examples 26 to 31 and Comparison Examples 32 and 33

For each example, the ingredients listed in Table 2 were mixed in the indicated quantities (in parts by weight) using a centrifugal mixer (SpeedMixer™ DAC 150, FlackTek Inc.). Using the mixed compositions, in each case a film with a layer thickness of approximately 2 mm was cast and this was stored for curing over 10 days under standard climate (23±1° C. and 50±5% relative humidity) conditions. The appearance of the films fully cured in this way was evaluated. A film was designated “defect-free” if it was clear and free from blisters and had a non-tacky surface. The term “fine blisters” was applied to a film that was otherwise defect-free, but had a few fine blisters. The term “few blisters” was applied to a film that was otherwise defect-free but contained a few blisters. In addition, the mechanical characteristics of the films fully cured in this way were evaluated in that a few dumbbell-shaped strips with a length of 75 mm, a bar length of 30 mm and a bar width of 4 mm were punched out of each of the films and tested according to DIN EN 53504 at a drawing speed of 200 mm/min for tensile strength (breaking force), elongation at break and modulus of elasticity (at 0.5-5.0% elongation), and the Shore hardness (A/D) was determined according to DIN 53505.

TABLE 2
Composition and properties of Examples 26 to 31 and Comparison examples 32 and 33.

| | Example | | | | | | | |
|---|---|---|---|---|---|---|---|---|
| | | | | | | | (Compar.) | (Compar.) |
| | 26 | 27 | 28 | 29 | 30 | 31 | 32 | 33 |
| Polymer P1 | 100.0 | 100.0 | 100.0 | 100.0 | 100.0 | 100.0 | 100.0 | 100.0 |
| D-2000 | 47.0 | 47.0 | 47.0 | — | 47.0 | 47.0 | 47.0 | 47.0 |
| SD-2001 | — | — | — | 47.0 | — | — | — | — |
| T-5000 | 10.0 | 10.0 | 10.0 | 10.0 | 10.0 | 10.0 | 10.0 | 10.0 |
| Example 6* | 68.1 | — | — | — | — | — | — | — |
| Example 8* | — | 62.1 | — | — | — | — | — | — |
| Example 9* | — | — | 69.8 | 69.8 | — | — | — | — |
| Example 10* | — | — | — | — | 56.5 | — | — | — |
| Example 16* | — | — | — | — | — | 52.2 | — | — |
| NH 1220 | — | — | — | — | — | — | 65.0 | — |
| Jefflink | — | — | — | — | — | — | — | 35.9 |
| Tens. strength | 6.0 | 1.3 | 5.4 | 2.8 | 2.2 | 2.9 | 3.4 | 2.1 |
| [MPa] | | | | | | | | |
| Elong, at break | 550 | 1040 | 450 | 370 | 500 | 850 | 930 | 500 |
| [%] | | | | | | | | |
| E-Mod. [MPa] | 88.5 | 8.2 | 92.9 | 44.6 | 10.5 | 25.4 | 3.8 | 28.6 |
| Shore hardness | 38 D | 72 A | 40 D | 28 D | 20 D | 21 D | 14 D | 27 D |
| Appearance | Defect- | Fine | Defect- | Defect- | Few | Defect- | Fine | Defect- |
| | free | blisters | free | free | blisters | free | blisters | free |

*polyamine of the specific example;
“Compar.” = “Comparison”,
“Tens. strength” = “Tensile strength:,”
“Elong. at break” = “Elongation at break,” and
“E-Mod.” = “Modulus of elasticity.”

Polymer P1:

151.0 g Jeffamine® SD-2001 (Huntsman) and 147.0 g isophorone diisocyanate (Vestanat® IPDI, Degussa) were reacted at room temperature to form a NCO-terminated quasi-prepolymer with a free isocyanate group content of 15.14 wt.-% and a viscosity at 20° C. of 660 mPa·s.

It is apparent from Table 2 that Examples 26 to 31 according to the invention cured to form high-quality films. Examples 26 and 28 have very high hardnesses, while Example 27 had very high ductility and flexibility. If the fully cured films containing the polyamines of Example 8 and Example 16, which have are based on the same initial primary amine PA but different aldehydes ALD (=Examples 27 and 31), the polyamine of Example 16 showed a distinctly higher hardness with likewise very high ductility of the fully cured film.

### Examples 34 to 40 and Comparison Examples 41 to 43

For each example, the ingredients shown in Table 3 in the indicated quantities (in parts by weight) were mixed for 15 seconds using a centrifugal mixer (SpeedMixer™ DAC 150, FlackTek Inc.). With the mixed compositions in each case the time to gelation of the mixture (called “gel time” for short) was determined in that in each case the viscosity of the mixed composition was measured at 20° C. at regular time intervals and the time from immediately after mixing until a viscosity of 100 Pa·s was exceeded was defined as the gel time.

TABLE 3
Composition and gel time of Examples 34 to 40 and comparison examples 41 to 43.

| | Example | | | | | | | | | |
|---|---|---|---|---|---|---|---|---|---|---|
| | | | | | | | | (Compar.) | (Compar.) | (Compar.) |
| | 34 | 35 | 36 | 37 | 38 | 39 | 40 | 41 | 42 | 43 |
| Polymer P1 | 5.60 | 5.86 | 5.83 | 5.54 | 6.06 | 5.98 | 6.24 | 7.07 | 7.74 | 5.71 |
| Ruetasolv | 5.00 | 5.00 | 5.00 | 5.00 | 5.00 | 5.00 | 5.00 | 5.00 | 5.00 | 5.00 |
| Ex. 6* | 4.40 | — | — | — | — | — | — | — | — | — |
| Ex. 7* | — | 4.14 | — | — | — | — | — | — | — | — |
| Ex. 8* | — | — | 4.17 | — | — | — | — | — | — | — |
| Ex. 9* | — | — | — | 4.46 | — | — | — | — | — | — |
| Ex. 10* | — | — | — | — | 3.94 | — | — | — | — | — |
| Ex. 11* | — | — | — | — | — | 4.02 | — | — | — | — |
| Ex. 16* | — | — | — | — | — | — | 3.76 | — | — | — |
| Jefflink | — | — | — | — | — | — | — | 2.93 | — | — |
| DETDA | — | — | — | — | — | — | — | — | 2.26 | — |
| NH 1220 | — | — | — | — | — | — | — | — | — | 4.29 |
| Gel time | 23 min. | 9 min. | 6 min. | 70 s | <10 s | 48 min. | 4 min. | 100 s | 110 s | 44 min. |

“Compar.” means “Comparison”
*Polyamine of the indicated Example.

It is apparent from Table 3 that Examples 34 to 40 according to the invention have comparatively long gel times. Except for Example 38, they fell in the range of just over one minute to just under one hour, wherein the primary amine PA forming the basis for the polyamine of Formula (I) exerted a strong effect on the reactivity. If Example 34 is compared with Comparison Example 41, both of which were based on isophorone diamine, it is apparent that the example according to the invention has a distinctly longer gel time.

1. A polyamine of Formula (I) 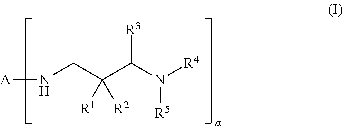
wherein
A represents the radical of an amine after removal of a primary aliphatic amino group;
a represents an integer from 1 to 6, provided that if a=1, the radical A has at least one reactive group selected from the group consisting of primary amino groups, secondary amino groups, hydroxyl groups and mercapto groups;
R¹ and R² represent either
independently of one another, a monovalent hydrocarbon radical having 1 to 12 C atoms,
or taken together, a divalent hydrocarbon radical having 4 to 12 C atoms, which is part of an optionally substituted carbocyclic ring having 5 to 8, preferably 6, C atoms;
R³ represents a hydrogen atom or an alkyl group or arylalkyl group or alkoxycarbonyl group having 1 to 12 C atoms each;
and either
R⁴ represents a monovalent aliphatic cycloaliphatic or arylaliphatic radical having 1 to 20 C atoms, which optionally contains oxygen atoms, and
R⁵ represents a hydrogen atom or a monovalent aliphatic, cycloaliphatic or arylaliphatic radical having 1 to 20 C atoms, which optionally contains oxygen atoms, or
R⁴ and R⁵ together represent a divalent aliphatic radical with 3 to 30 C atoms which is part of an optionally substituted heterocyclic ring having 5 to 8, preferably 6, ring atoms, wherein this ring in addition to the nitrogen atom optionally contains additional heteroatoms.

2. The polyamine of Formula (I) according to claim 1, characterized in that R¹ and R² each represents a methyl radical and/or R³ represents a hydrogen atom.

3. The polyamine of Formula (I) according to claim 1, characterized in that either R⁴ represents methyl, ethyl, propyl, isopropyl, butyl, 2-ethylhexyl, cyclohexyl, 2-hydroxyethyl, 2-hydroxypropyl, 2-methoxyethyl or benzyl and R⁵ represents hydrogen or methyl, ethyl, propyl, isopropyl, butyl, 2-ethylhexyl, cyclohexyl, 2-hydroxyethyl, 2-hydroxypropyl, 2-methoxyethyl or benzyl, or R⁴ and R⁵ together—including the nitrogen atom—form a ring, especially a pyrrolidine, piperidine, morpholine or N-alkylpiperazine ring, wherein this ring or the alkyl group is optionally substituted.

4. The method for producing a polyamine of Formula (I) according to claim 1, characterized in that at least one amine PA of Formula (II) is reductively alkylated with at least one aldehyde ALD of Formula (III).

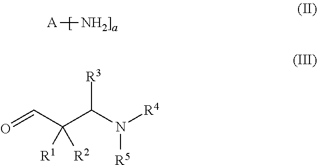

5. The method for producing a polyamine of Formula (I) according to claim 4, characterized in that the process is conducted in such a manner that at least one amine PA of Formula (II) is condensed with at least one aldehyde ALD of Formula (III) to form an imine and this is then hydrogenated.

6. The method according to claim 4, characterized in that the amine PA of Formula (II) is selected from the group consisting of 1,5-diamino-2-methylpentane (MPMD), 2-butyl-2-ethyl-1,5-pentanediamine (C11-neodiamine), 1,6-hexanediamine, 2,5-dimethyl-1,6-hexanediamine, 2,2,4- and 2,4,4-trimethyl-hexamethylenediamine (TMD), 1,12-dodecanediamine, 1,4-diamino-cyclohexane, bis-(4-aminocyclohexyl)-methane (H₁₂-MDA), bis-(4-amino-3-methylcyclohexyl)-methane, 1-amino-3-aminomethyl-3,5,5-trimethylcyclohexane isophorone diamine or IPDA), 1,3-bis-(aminomethyl)-cyclohexane, 2,5(2,6)-bis-(aminomethyl)-bicyclo[2.2.1]-heptane (NBDA), 3(4),8(9)-bis-(aminomethyl)-tricyclo[5.2.1.0^{2,6}]decane, 1,3-xylylenediamine, bis-hexamethylenetriamine (BHMT), diethylenetriamine (DETA), triethylenetetramine (TETA), tetraethylene pentamine (TEPA), pentaethylenehexamine (PEHA), polyethylenepolyamine having 5 to 7 ethyleneamine units (so-called “higher ethylenepolyamines,” HEPA), dipropylenetriamine (DPTA), N-(2-aminoethyl)-1,3-propanediamine (N3-amine), N,N′-bis(3-aminopropyl)-ethylenediamine (N4-amine), polyoxyalkylenediamines and polyoxyalkylenetriamines, especially with a molecular weight of 200 to 6000 g/mol.

7. The method according to claim 4, characterized in that the aldehyde ALD of Formula (III) is selected from the group consisting of 2,2-dimethyl-3-methylamino-propanal, 2,2-dimethyl-3-dimethylamino-propanal, 2,2-dimethyl-3-ethylamino-propanal, 2,2-dimethyl-3-diethylamino-propanal, 2,2-dimethyl-3-bis(2-methoxyethyl)amino-propanal, 2,2-dimethyl-3-butylamino-propanal, 2,2-dimethyl-3-dibutylamino-propanal, 2,2-dimethyl-3-hexylamino-propanal, 2,2-dimethyl-3-(2-ethylhexyl)amino-propanal, 2,2-dimethyl-3-dodecyclamino-propanal, 2,2-dimethyl-3-(N-pyrrolidino)-propanal, 2,2-dimethyl-3-(N-piperidino)-propanal, 2,2-dimethyl-3-(N-morpholino)-propanal, 2,2-dimethyl-3-(N-(2,6-dimethyl)-morpholino)-propanal, 2,2-dimethyl-3-bezylamino-propanal, 2,2-dimethyl-3-(N-benzylmethylamino)-propanal, 2,2-dimethyl-3-(N-benzylisopropylamino)-propanal, 2,2-dimethyl-3-cyclohexylamino-propanal, 2,2-dimethyl-3-(N-cyclohexylmethylamino)-propanal and N,N′-bis(2,2-dimethyl-3-oxopropyl)-piperazine.

8. An adduct AD, obtained from the reaction of at least one polyamine of Formula (I) according to claim 1 with at least one compound VB that bears at least one, preferably at least two, reactive groups RG, wherein the reactive groups RG are selected from the group consisting of isocyanate, isothiocyanate, cyclocarbonate, epoxide, episulfide, aziridine, acrylate, methacrylate, 1-ethinylcarbonyl, 1-propinylcarbonyl, maleimide, citraconimide, vinyl, isopropenyl and allyl groups.

9. The adduct AD according to claim 8, characterized in that it is an adduct AD1 containing at least two amino groups of Formula (VIII).

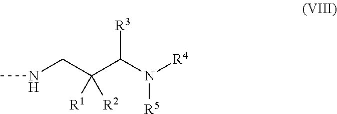

10. The adduct AD according to claim 8, characterized in that it is an adduct AD2 containing at least two isocyanate groups, wherein a polyisocyanate was used as compound VB.

11. An isocyanate group-containing composition Z1, containing
a) at least one polyisocyanate, and
b) at least one curing agent compound HV, which has at least two reactive groups selected from the group consisting of primary amino groups, secondary amino groups, hydroxyl groups and mercapto groups;
provided that the polyisocyanate and/or the curing agent compound HV is a compound selected from the group consisting of the polyamines of Formula (I) according to claim 1, the adducts AD1 containing at least two amino groups, and the adducts AD2 containing at least two isocyanate groups.

12. A fully cured composition obtained from the reaction of at least one polyisocyanate with at least one curing agent compound HV of an isocyanate group-containing composition Z1 according to claim 11.

13. Epoxy resin compositions Z2, containing
a) at least one epoxy resin, and
b) at least one polyamine of Formula (I) according to claim 1.

14. Fully cured composition obtained from the reaction of at least one epoxy resin with at least one polyamine of Formula (I) of an epoxy resin composition Z2 according to claim 13.

15. The use of a polyamine of Formula (I) according to claim 1 or an adduct AD according to one of claims 8 to 10 in cleaning agents, fuels, lubricants, asphalts, rubber articles, pharmaceuticals, pesticides, grinding aids, sequestrants, petroleum production aids, paper chemicals, fiber-composite materials (composites), potting compounds, sealants, adhesives, linings, coatings, paints, lacquers, sealing compounds, base coats, primers, foams, molding blocks, elastomers, fibers, films and membranes.
